(19) United States
(12) Patent Application Publication
(10) Pub. No.: US 2025/0069787 A1
(43) Pub. Date: Feb. 27, 2025

(54) METHOD FOR PREPARING ACID RESISTANT MAGNETIC PARTICLES AND ACID RESISTANT MAGNETIC PARTICLES

(71) Applicant: Roche Diagnostics Operations, Inc., Indianapolis, IN (US)

(72) Inventors: Martin Eduardo Silvestre, Weilheim (DE); Sabine Eisold, Muenchen (DE); Dieter Heindl, Muenchen (DE); Kristina Peters, Wolfratshausen (DE)

(21) Appl. No.: 18/713,584

(22) PCT Filed: Nov. 23, 2022
(86) PCT No.: PCT/EP2022/083050

§ 371 Date: May 24, 2024

(30) Foreign Application Priority Data
Nov. 25, 2021 (EP) 21210509.2

(51) Int. Cl. H01F 1/33; H01F 1/00; H01F 1/34

(52) U.S. Cl. CPC H01F 1/33; H01F 1/0054; H01F 1/344

(57) ABSTRACT

In a first aspect, the invention relates to a method for preparing a magnetic bead comprising at least one magnetic particle (M) and a silica coating, wherein the silica coating comprises at least two silica layers, the method comprising steps (a) to (d), wherein at least one of steps (b), (c) and (d) is/are done under sonication, wherein sonication is done with an amplitude (peak-to-peak) in the range of from 50 to 250 μm. A second aspect of the invention is related to a magnetic bead comprising (i) at least one magnetic particle (M) and (ii) a silica coating, wherein the silica coating comprises at least two silica layers; wherein the magnetic bead is stable against 7.5 M hydrochlorid acid and has a metal (cation) leaching rate in 7.5 M hydrochloric acid in the range of from 0.1 to 10%, wherein the metal (cation) leaching is determined according to a complex formation of Fe²⁺ with bathophenanthroline according to Reference Example 8.2. In a third aspect, the invention relates to a functionalized magnetic bead comprising at least one, magnetic bead according to the second aspect, wherein an outer silica layer is functionalized with at least one group selected from the group consisting of amino group, azide group, alkyne group, carboxyl group, thiol group, epoxy group, aryl group and alkyl group. A fourth aspect of the invention is directed to a process for functionalizing a magnetic bead according to the second aspect comprising at least one magnetic particle (M) and a silica coating, wherein the silica coating comprises at least two silica layers. A fifth aspect of the invention is related to a method for preparing magnetic Fe₃O₄ supra particles and a sixth aspect relates to the use of a magnetic bead according to the second aspect or of a functionalized according to the fourth aspect for immobilization of acid stable biocatalysts or for solid-phase organic synthesis using acid-stable linker.

### FIELD OF THE INVENTION

In a first aspect, the invention relates to a method for preparing a magnetic bead comprising at least one magnetic particle (M) and a silica coating, wherein the silica coating comprises at least two silica layers, the method comprising steps (a) to (d), wherein at least one of steps (b), (c) and (d) is/are done under sonication with an amplitude (peak-to-peak) in the range of from 50 to 250 μm. A second aspect of the invention is related to a magnetic bead comprising (i) at least one magnetic particle (M) and (ii) a silica coating, wherein the silica coating comprises at least two silica layers; wherein the magnetic bead is stable against 7.5 M hydrochlorid acid and has a metal (cation) leaching rate in 7.5 M hydrochloric acid in the range of from 0.1 to 10%. In a third aspect, the invention relates to a functionalized magnetic bead comprising at least one magnetic bead according to the second aspect, wherein an outer silica layer is functionalized with at least one group selected from the group consisting of amino group, azide group, alkyne group, carboxyl group, thiol group, epoxy group, aryl group and alkyl group. A fourth aspect of the invention is directed to a process for functionalizing a magnetic bead according to the second aspect comprising at least one magnetic particle (M) and a silica coating, wherein the silica coating comprises at least two silica layers. A fifth aspect of the invention is related to a method for preparing magnetic Fe₃O₄ supra particles and a sixth aspect relates to the use of a magnetic bead according to the second aspect or of a functionalized according to the fourth aspect for immobilization of acid stable biocatalysts or for solid-phase organic synthesis using acid-stable linker.

### RELATED ART

Magnetic particles are widely used for capturing analytes from human samples for diagnostic applications. The magnetic properties allow for a fast and cheap automation on diagnostic systems by avoiding time-consuming centrifugation or filtration steps. However, beside the magnetization, also further properties are indispensable. The particle size has to be large enough to enable a fast magnetic separation, but needs to be small enough to show acceptable sedimentation behavior and allow application in microfluidic systems without tube clogging. This can only be achieved by using magnetic materials showing a low magnetic remanence, as those only show magnetization when an external magnetic field is applied. In the absence of an external magnetic field, magnetization appears to be low (no “memory effect”). Further, the particles have to be functionalized with functional groups to enable binding of analytes using, for example, click chemistry. Nevertheless, the most essential property is the stability of the final composites in hydrochloric acid with a concentration higher than or equal to 7.5M for at least 30 min without significant iron leaching.

Magnetic nanoparticles can be prepared by various chemical- or physical-based synthetic methods, including chemical (co-)precipitation, the reverse micelle method, microwave plasma synthesis, sol-gel techniques, freeze drying, ultrasound irradiation, hydro- and solvothermal methods, laser pyrolysis techniques and thermal decomposition of organometallic and coordination compounds. However, in most of these approaches, like in the commonly used precipitation method, the size distribution and shape of the as synthesized particles can only be controlled to few extents. Solvothermal methods offer the possibility to avoid this shortcoming and to synthesize uniform and hydrophilic particles.[1], [2] In general, there are three major methods for the synthesis of silica-coated magnetic nanoparticles.[3] The first and most common method due to relatively mild reaction conditions and low cost is a sol-gel process, which is also known as the so called Stöber method.[4] It relies on the use of silicon alkoxides (like (3-aminopropyl)triethoxysilane (APTES) and tetraethoxysilane (TEOS)) as the source of silica that form a silica phase on colloidal magnetic nanoparticles in a basic alcohol/water mixture.[1] The second approach is based on either in situ formation of magnetic nanoparticles inside the pores of pre-synthesized silica using metal compounds (i.e. salts, complex or alkoxides) as the source of magnetic phase.[5] The third method is called aerosol pyrolysis, in which silica-coated magnetic nanoparticles were prepared by aerosol pyrolysis of a precursor mixture composed of silicon alkoxides and metal compound in a flame environment.[6]

Silica coating has several advantages over other coatings like polymers and surfactants. Silica formed on the surface of magnetic nanoparticles can prevent agglomeration by shielding the magnetic dipolar attraction between magnetic nanoparticles, which favors the dispersion of magnetic nanoparticles in liquid media and it also protects them from leaching in an acidic environment. Silica-coated magnetic nanoparticles can be easily functionalized with various functional groups due to the existence of abundant silanol groups on the silica surface. A direct functionalization is the easiest way to introduce the desired groups; particular as such functional silanes are commercially available from various vendors. Alternatively, functional groups can be introduced by chemical modification of amine, thiol or chloride functionalized particles.

The Particles described by Mahtab et al[7] and Deng et al[1], do not meet the requirements for automation due to small particle size and low magnetization. It is difficult to produce larger particles than 100 nm with magnetization values above 15 emu/g using these methods, giving a low potential of this synthesis routes for the production of particles with the required properties. Pu et al[8] describe core shell particles stable towards 0.05M HCl, however iron leaking could be observed. Zhu et al[9] coated commercial carbonyl iron particles (CIP) with silica, to achieve stability in 1M HCl for 4 h. Dupont et al[10] prepared core-shell Fe₃O₄—SiO₂ nanoparticles that show stability in 1M HCl, however also here a particle loss (dissolution, iron leaking) of 8% could be observed. Cendrowski et al[11] coated commercial pristine nanoparticles of magnetite with a 20 nm thick silica layer that significantly enhanced the chemical and thermal stability of the iron oxide. The particles are stable in 12M HCl. However still a certain amount of iron leaking could be observed. Unfortunately no magnetic properties and size measurements in solution are shown, which are key requirements for automation. Xin et al[12] synthesized uniform magnetic microspheres using a hydrothermal method, which are stable in 1-3M HCl for 5-15 min (used for particle washing). No further stability data or iron leakage rates are shown. Jianlin et al[13] and Yinya et al[14] used 4-6M and 2M HCl for washing the magnetic nanoparticles after their synthesis (before silica coating), however a strong iron leakage can be assumed, as the solution turns green. Zhiping et al[15], [16] developed core-shell particles composed of a Fe₃O₄ magnetic particle core, silicon oxide, a hydrophobic layer and a high-molecular polymer layer. The composites are stable under sulfuric acid and hydrochloric acid conditions being higher than 3M or 1-2M, respectively. However, the document is silent when it comes to iron leakage data. Rong et al[17] synthesized core-shell particles composed of Fe₃O₄@SiO₂@DtBuCH₁₈C₆ that were stable towards 1.7M HNO₃.

Thus, the particles of the prior art do not fulfill requirements needed for automation, for example, a suitable combination of stability towards 7.5M HCl (hydrochloric acid), magnetic properties and size as well as avoidance of agglomeration. Also not only the particles itself, but also the introduced functional groups have to be stable towards 7.5M HCl.

The technical problem underlying the present invention was thus the provision of magnetic beads and a process for their preparation, wherein the magnetic beads should be stable towards higher concentrated acidic solutions, preferably 7.5M HCl, while also fulfilling the other requirements indicated above.

### SUMMARY OF THE INVENTION

The problem is solved by the invention with the features of the independent patent claims. Advantageous developments of the invention, which can be realized individually or in combination, are presented in the dependent claims and/or in the following specification and detailed embodiments.

As used in the following, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once, typically will be used only once when introducing the respective feature or element. In the following, in most cases, when referring to the respective feature or element, the expressions “at least one” or “one or more” will not be repeated, notwithstanding the fact that the respective feature or element may be present once or more than once.

Further, as used in the following, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restrictions regarding the scope of the invention and without any restriction regarding the possibility of combining the features introduced in such a way with other optional or non-optional features of the invention.

### 1^{st} Aspect—Method for Preparing a Magnetic Bead Omprising at Least One Magnetic Particle (M) and a Silica Coating, Wherein the Silica Coating Comprises at Least Two Silica Layers

In a first aspect, the invention relates to a method for preparing a magnetic bead comprising at least one magnetic particle (M) and a silica coating, wherein the silica coating comprises at least two silica layers, the method comprising:
(a) Providing at least one magnetic particle (M) having a first silica layer on its outer surface;
(b) Dispersing the at least one magnetic particle (M) having a first silica coating on its outer surface according to (a) in an alcoholic solvent thereby obtaining a dispersion of the at least on magnetic particle (M) having a first silica layer on its outer surface;
(c) Adjusting the pH of the dispersion obtained in (b) to a value of >7, thereby obtaining a basic dispersion of the at least one magnetic particle (M) having a first silica layer on its outer surface;
(d) Adding a silica source to the dispersion of the at least one magnetic particle (M) having a first silica layer on its outer surface obtained in (c);
   thereby obtaining a dispersion comprising a magnetic bead comprising at least one magnetic particle (M) and a silica coating, wherein the silica coating comprises two silica layers;
wherein at least one of steps (b), (c) and (d) is/are done under sonication, wherein sonication is done with an amplitude (peak-to-peak) in the range of from 50 to 250 μm.

Regarding stability, it could be seen that one step coated beads are already stable in HCl, however they showed a higher iron loss (>5%) compared to multishell beads prepared by the inventive process. Already the second coating layer applied by the inventive process improves the stability towards acids significantly, wherein the stability towards acids increases with each coating step, while maintaining high magnetization and low magnetic remanence. The undesired effect of agglomeration within the coating process is significantly reduced by using sonication. The resulting particles are smaller in their hydrodynamic diameter and also less agglomerates form.

“Silica coating” means that the coating comprises silica, preferably at least 90% by weight, more preferably at least 95% by weight, more preferably at least 99% by weight, of the coating consist of silica. “Silica” means silicon dioxide (SiO₂), preferably in amorphous form. “Coating” means that the at least one magnetic particle (M) is sourounded by silica, wherein preferably at least 99%, more preferably at least 99.5%, more preferably at least 99.9% of the surface of the magnetic particle (M) are covered by silica.

The alcoholic solvent used according to (b) is preferably a mixture comprising a C1 to C10 alcohol and water, wherein the C1 to C10 alcohol is preferably a C1 to C5 monool, more preferably ethanol. Preferably, the alcoholic solvent comprises in the range of from 20 to 95 volume-% of alcohol and in the range of from 5 to 80 volume-% of water, more preferably the alcoholic solvent comprises in the range of from 50 to 90 volume-% of alcohol and in the range of from 10 to 50 volume-% of water, more preferably the alcoholic solvent comprises in the range of from 70 to 90 volume-% of alcohol and in the range of from 10 to 30 volume-% of water, each based on 100 volume-% of alcoholic solvent, wherein the alcoholic solent more preferably comprises, more preferably consists of 80 volume-% of alcohol, preferably ethanol and 20 volume-% of water.

The silica source according to (d) is preferably an organic silica source, more preferably a silicon alkoxide, more preferably a silicon alkoxide selected from the group consisting of (3-aminopropyl)triethoxysilane (APTES), tetraethoxysilane (TEOS) and mixtures of APTES and TEOS.

Preferably, all steps (a) to (d) are carried out at a temperature in the range of from 5 to 50° C., more preferably in the range of from 10 to 40° C., more preferably in the range of from 15 to 25° C.

“Sonication” preferably means ultrasoniation, i.e. a treatment with ultrasound. The (ultra)sonication time is preferably in the range of from 0.1. to 48 hours, more preferably in the range of from 0.5 to 24 hours, more preferably in the range of from 2 to 12 hours, more preferably in the range of from 3 to 10 hours, more preferably in the range of from 4 to 8 hours. The temperature at which the (ultra)sonication is carried out is preferably in the range of from 5. to 50° C., more preferably in the range of from 15 to 30° C. To compensate for the energy input/heat input due to the ultrasonic treatment, temperature control combined with temperature adjustment is done during the sonication. Preferably, a double jacket reactor is used, which is connected to a thermostat. A cooling medium flows through the cooling jacket. The nature of the cooling medium is not particular restricted as long as it is sufficient for adjusting the temperature in the cooling jacket and consequently, in the reactor. Control of the jacket temperature, i.e. of the cooling medium flowing therethrough, is done via a temperature sensor in the reaction solution. The (ultra)sonication frequency is preferably in the range of from 1 to 100 kHz, more preferably in the range of from 15 to 50 kHz, more preferably in the range of from 20 to 30 kHz. According to one embodiment of the method, at least steps (b) and (c) and/or (d), more preferably steps (b), (c) and (d), is/are done under sonication, and/or (ultra)sonication is done with an (ultra)sonic amplitude (peak-to-peak) in the range of from 90 to 180 μm, wherein (ultra)sonication is preferably done in an ultrasonic flow cell, preferably under continuous flow, more preferably under continuous flow with a flow rate in the range of from 100 to 1000 ml/min, preferably in the range of from 200 to 700 ml/min, more preferably in the range of from 400 to 600 ml/min. According to a preferred embodiment, steps (b), (c) and (d) are done under sonication, and/or the (ultra)sonication is done with an (ultra)sonic amplitude (peak-to-peak) in the range of from 90 to 180 μm.

The (ultra)sonic amplitude means the amplitude of vibration of the (ultra)sonic source. The intensity of(ultra)sonication is proportional to the amplitude of vibration of the (ultra)sonic source. The (ultra)sonic source is preferably a sonotrode, wherein the material of the (ultra)sonic source, preferably the sonotrode is selected from the group consisting of titanium, glass, ceramic and mixtures of two or more of these materials. Preferably, a sonotrode made of titanium is used. Desing, materials and setup of ultrasonic flow cells, are known to the skilled person.

A “magnetic bead” may, in principle, display any geometrical form, however, preferably, the particle is substantially spherical. As used herein, the term “substantially spherical” refers to particles with rounded shapes that are preferably non-faceted or substantially free of sharp corners. In certain embodiments, the substantially spherical particles typically have an average aspect ratio of less than 3:1 or 2:1, for example, an aspect ratio less than 1.5:1, or less than 1.2:1. In a certain embodiment, substantially spherical particles may have an aspect ratio of about 1:1. The aspect ratio (A_{R}) is defined as being a function of the largest diameter (dₘₐₓ) and the smallest diameter (dₘᵢₙ) orthogonal to it (A_{R}=dₘᵢₙ/dₘₐₓ). The diameters are determined via SEM or light microscope measurements.

In one embodiment, the at least one “magnetic particle (M)” comprises a compound selected from the group consisting of metal, metal carbide, metal nitride, metal sulfide, metal phosphide, metal oxide, metal chelate and a mixture of two or more thereof.

It is to be understood that each magnetic particle (M) may comprise a mixture of two or more of the above-mentioned group, i.e. two or more of a metal, metal carbide, metal nitride, metal sulfide, metal phosphide, metal oxide, a metal chelate and a mixture of two or more thereof. Further, mixtures of two or more different metals, two or more different metal oxides, two or more different metal carbides, two or more different metal nitrides, two or more different metal sulphides, two or more different metal phosphides, two or more different metal chelates are conceivable. Further, it is to be understood that in case the magnetic bead comprises more than one magnetic particle (M), each of the magnetic particles (M) present in a single magnetic bead may be the same or may differ from each other. Preferably, all magnetic particles (M) comprised in one magnetic particle are the same. More preferably, the at least one magnetic particle (M) comprises a metal oxide.

Thus, in one embodiment, the at least one magnetic particle (M) comprises a metal oxide, more preferably, an iron oxide, in particular an iron oxide selected from the group consisting of Fe₃O₄, α-Fe₂O₃, γ-Fe₂O₃, MnFeₓO_{y}, CoFeₓO_{y}, NiFeₓO_{y}, CuFeₓO_{y}, ZnFeₓO_{y}, CdFeₓO_{y}, BaFeₓO and SrFeₓO, wherein x and y vary depending on the method of synthesis, and wherein x is preferably an integer of from 1 to 3, more preferably 2, and wherein y is preferably 3 or 4 most preferably, Fe₃O₄.

In one preferred embodiment, the magnetic particle (M) and thus the magnetic bead is superparamagnetic. The term “superparamagnetic” is known to the person skilled in the art and refers to the magnetic property encountered in particular for particles smaller than a single magnetic mono-domain. Such particles steadily orient upon applying an external magnetic field until a maximum value of the global magnetization, dubbed saturation magnetization, is reached. They relax when removing the magnetic field, with no magnetic hysteresis (no remanence) at room temperature. In the absence of an external magnetic field, superparamagnetic particles exhibit a nonpermanent magnetic moment due to thermal fluctuations of the dipole orientation (Neel relaxation) and particle position (Brownian relaxation).

The magnetic particles (M) are preferably present in the center of the magnetic bead forming one or more so called “core(s)”.

The magnetic particles (M) preferably comprise, more preferably consist of nanoparticles. The nanoparticles are preferably the part which displays the magnetism, preferably superparamagnetism of a particle. Nanoparticles are sometimes also referred to as “magnetic nanoparticles” herein. As used herein, the term “nanoparticle” refers to a particle being less than 100 nanometers in at least one dimension, i.e. having a diameter of less than 100 nm. Preferably, the nanoparticle according to the invention has a diameter in the range of from 1 to 20 nm, preferably 4 to 15 nm, as determined according to TEM-measurements. Each nanoparticle has a diameter in the range of from 1 to 20 nm, preferably 4 to 15 nm, as determined according to TEM-measurements. Preferably, the at least one magnetic nanoparticle is superparamagnetic.

The magnetic particle (M) may comprise only one nanoparticle or more than one nanoparticle. In one embodiment, it comprises from 1 to 20 nanoparticles. In another embodiment, it comprises more than 20 nanoparticles, preferably 100 to 1.5 million nanoparticles, more preferably 750-750,000 nanoparticles, more preferably 1,750 320,000 nanoparticles, in particular 90,000-320,000 nanoparticles. The nanoparticles may form aggregates consisting of several nanoparticles. Theses aggregates may have different sizes depending on the number of included nanoparticles. In one embodiment, so called supraparticles are formed. According to this embodiment, the magnetic particle (M) comprises more than 20 nanoparticles, and, typically more than 100 nanoparticles, wherein these nanoparticles are preferably aggregated with each other to form a supraparticle. More preferably, in this case, the magnetic particle (M) comprises a supraparticle consisting of aggregated nanoparticles. Preferably, in this case, the magnetic particle (M) comprises a supraparticle which comprises between 100 to 1.5 million nanoparticles more preferably 750-750,000 nanoparticles, more preferably 1,750-320,000 nanoparticles, in particular 90,000-320,000 nanoparticles. In a preferred embodiment, where a supraparticle is present, the magnetic particle (M) comprising the supraparticle is present in the center of the magnetic bead and forms a so called “core”. Preferably, such a core formed by magnetic particles (M) has a diameter in the range of from 80 to 500 nm, more preferably 150 to 400 nm, and most preferably 200 to 300 nm, as determined according to DLS (ISO 22412). Preferably the amount of magnetic particles (M) is chosen so that a desired saturation magnetization saturation of the magnetic bead is achieved.

According to an embodiment of the method for preparing a magnetic bead comprising at least one magnetic particle (M) and a silica coating, wherein the silica coating comprises at least two silica layers, the method comprises:
(e) Separating a magnetic bead comprising at least one magnetic particle (M) and a silica coating, wherein the silica coating comprises two silica layers from the dispersion obtained in (d).

Regarding the magnetic bead comprising at least one magnetic particle (M) and a silica coating, wherein the silica coating comprises two silica layers separated in (e), it is preferred that the at least on magnetic particle (M) having a first silica layer on its outer surface has the second silica layer directly on the first silica layer.

According to a further embodiment of the method for preparing a magnetic bead comprising at least one magnetic particle (M) and a silica coating, wherein the silica coating comprises at least two silica layers, the method further comprises:
(f) Providing at least one magnetic particle (M) having a first silica layer on its outer surface and a second silica layer (directly) on the first silica layer; and repeating the sequence of steps (b), (c), (d) and optionally (e) at least once, preferably in the range of from 1 to 8 times, more preferably in the range of from 1 to 6 times, more preferably in the range of from 1 to 3 times, hereby obtaining a magnetic bead comprising at least one magnetic particle (M) and a silica coating, wherein the silica coating comprises in the range of from 3 to 10, more preferably in the range of from 3 to 8, more preferably in the range of from 3 to 5, silica layers.

The invention is also related to a magnetic bead comprising at least one magnetic particle (M) and a silica coating, wherein the silica coating comprises at least two silica layers, obtained or obtainable from the method as described above with respect to the first aspect.

### 2^{nd} Aspect—Magnetic Bead

In a second aspect, the invention relates to a magnetic bead comprising
(i) at least one magnetic particle (M) and
(ii) a silica coating, wherein the silica coating comprises at least two silica layers;
wherein the magnetic bead is stable against 7.5 M hydrochlorid acid and has a metal (cation) leaching rate in 7.5 M hydrochloric acid in the range of from 0.1 to 10%, wherein the metal (cation) leaching is determined according to a complex formation of Fe²⁺ with bathophenanthroline (4,7-phenylsulfonyl-1,10-phenanthroline) according to Reference Example 8.2.

In some preferred embodiments, the magnetic bead of the second aspect is brained or obtainable from the method as described above with respect to the first aspect. All details disclosed above in the section related to the first aspect of the invention also apply with respect to the second aspect, especially in view pf stability, silica coating, magnetic bead and magnetic particle (M).

According to an embodiment, the magnetic bead has a stability against acids, preferably against HCl, wherein the value of the magnetization of the magnetic bead after an acid treatment changes (preferably decreases) by less than 6%, preferably by less than 5.5%, more preferably by less than 5%, compared to the bead's magnetization before acid treatment, wherein the acid treatment is preferably a treatment with 7.5 M HCl for 30 minutes, preferably as in Reference Example 8.1.

According to an embodiment of the magnetic bead, the silica coating according to (ii) comprises in the range of from 2 to 10 silica layers, preferably in the range of from 2 to 8 silica layers, more preferably in the range of from 2 to 5 silica layers more preferably in the range of from 3 to 4 silica layers.

According to an embodiment, the magnetic bead has an average particle size in the range of from 0.2 to 5 μm as determined according to Reference Example 3.1.

According to an embodiment of the magnetic bead, each silica layer has an thickness in the range of from 10 to 40 nm, preferably determined based on a REM picture. In some preferred embodiments, the first two silica layers have an overall thickness of about 25 nm and the third silica layer has a thickness of also about 25 nm, amounting to an overall thickness of the three silica layers of about 50 nm.

According to an embodiment of the magnetic bead, the magnetization loss per layer is in the range of from 5 to 25 Am²/kg per silica layer, determined according to Reference Example 1.

According to a preferred embodiment, the magnetic bead has a metal (cation) leaching rate, preferably an iron cation leaching rate, in 7.5 M hydrochloric acid in the range of from 0.5 to 5%, preferably <5% in case of two silica layers and <1% in case of three silica layers, wherein the metal (cation) leaching in 7.5 M hydrochloric acid is determined according to a complex formation of Fe²⁺ with bathophenanthroline according to Reference Example 8.2. The metal (cation) leaching rate in 7.5 M hydrochloric acid after a 1^{st} coating, i.e. with only one silica layer, is about 25%.

According to an embodiment, the magnetic bead has a surface area in the range of from 30 to 300 m² per kg of the magnetic bead, determined according to Reference Example 5. According to an embodiment, the magnetic bead has a saturation magnetization of at least 25 A m² per kg of the magnetic bead, as determined according to Reference Example 1. According to an embodiment, the magnetic bead has a magnetic remanence of ≤3 A m² per kg of the magnetic bead, determined according to Reference Example 1.

According to an embodiment, the magnetic bead has a stability against acids, preferably against HCl, wherein the value of the magnetic remanence of the magnetic bead after an acid treatment, changes (preferably decreases) by <100%, preferably by less than 50%, more preferably by less than 15%, compared to the bead's magnetic remanence before acid treatment, wherein the acid treatment is preferably a treatment with 7.5 M HCl for 30 minutes, preferably as in Reference Example 8.1.

### 3^{rd} Aspect—Functionalized Magnetic Bead

A third aspect of the invention is related to a functionalized magnetic bead comprising at least one magnetic bead obtained or obtainable from the method of the first aspect as described above or according to the second aspect as described above, wherein an outer silica layer is functionalized with at least one group selected from the group consisting of amino group, azide group, alkyne group, carboxyl group, thiol group, epoxy group, aryl group and alkyl group. “Aryl group” preferably means a phenyl group and “alkyl group” preferably means a C2 to C20 alkyl group.

The stability of hydrophobic functional coatings, i.e. of the functionalized magnetic bead according to the third aspect, is proven by a hydrophobicity test, done before and after acid (HCl) treatment. It was apparent that also the functionalized magnetic bead are stable with respect to acid (HCl) treatment.

All details disclosed above in the sections related to the first aspect (method for preparing a magnetic bead comprising at least one magnetic particle (M) and a silica coating, wherein the silica coating comprises at least two silica layers) and the second aspect of the invention (magnetic bead comprising at least one magnetic particle (M) and a silica coating, wherein the silica coating comprises at least two silica layers) also apply with respect to the magnetic bead in the context of the third aspect.

According to an embodiment of the functionalized magnetic bead, the functional group is bound to the outer silica layer by a structure element (I)

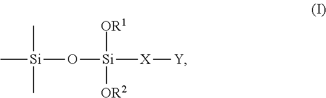

wherein
Si connected by three dotted lines represents a silicon atom in the outer silica layer;
R¹, R² are idependently selected from hydrogen atom, C1 to C5 alkyl group, preferably methyl group or ethyl group, and a bond to a further Silicon atom in the outer silica layer;
X represents a spacer group; and
Y represents a functional group selected from the group consisting of amino group, azide group, alkyne group, carboxyl group, thiol group, epoxy group, aryl group and alkyl group.

Regarding Y, “aryl” preferably means a phenyl group and “alkyl group” preferably means a C2 to C20 alkyl group. The spacer group X preferably consists of, a chain of atoms forming a backbone, wherein the backbone has a length in the range of from 2 to 50 atoms, preferably a length in the range of from 2 to 40 atoms, more preferably a length in the range of from 2 to 30 atoms, more preferably a length in the range of from 2 to 20 atoms. All atoms forming the backbone are covalently bondend to each other. In one embodiment, the backbone consists of carbon atoms and one or more heteroatoms selected from O, N and S, optionally comprising at least one aryl, heteroaryl, substituted aryl or substituted heteroaryl group (wherein e.g. a phenylene ring accounts for a length of four atoms). Heteroatoms at interior positions are unsubstituted or have one or more substituents selected from the group consisting of hydrogen atom, C1-C10 alkyl and ═O, wherein each C1-C10 alkyl may be unsubstituted or substituted with a N[(CH₂)ᵣCOO(H)]₂ group. In some embodiments, the one or more heteroatom(s) are part of a linkage, wherein the linkage is preferably selected from the group consisting of ether linkage, amide linkage, ester linkage, carbamate linkage and urea linkage. Carbon atoms in the chain of atoms of the backbone are substituted with one or more substituents selected from the group consisting of hydrogen atom and C1 to C10 alkyl group, wherein each C1 to C10 alkyl group may be unsubstituted or may have at least one substituent selected from hydroxyl group, amino group or carboxyl goup. The term “alkyl” by itself or as part of another substituent, means, unless otherwise stated, a straight or branched chain, or cyclic hydrocarbon radical, or combination thereof, having the number of carbon atoms designated (i.e. C1-C10 means one to ten carbon atoms). Examples of saturated hydrocarbon radicals include, but are not limited to, groups such as methyl, ethyl, n-propyl, isopropyl, n-butyl, t-butyl, isobutyl, sec-butyl, cyclohexyl, (cyclohexyl)methyl, cyclopropylmethyl, homologs and isomers of, for example, n-pentyl, n-hexyl, and the like.

According to an embodiment of the functionalized magnetic bead, the spacer group X is selected from the group consisting of C2 to C20 alkyne group (3-Azidopropyl-triethoxysilane, 11-Azidoundoundecyl-triethoxysilane, Carboxyethylsilanetriol, Trimethoxy-(octadecyl)-silan), which optionally has one or more substituents selected from hydrogen atom and —(CH₂)—COOH group (3-Triethoxysilyl)propylsuccinic anhydride), —(CH₂)ₙ—NH—C(═O)-[(CH₂)ₘ—O—]— group (Propargyl-PEG3-triethoxysilan), —(CH₂)ₙ—CH(OH)—CH₂—NH—[(CH₂)ₘ—O—]— group (2-[2-(2-propynyloxy)ethoxy]ethylamine)+epoxy functionalized beads), —(CH₂)ₙ—NHC(═O)—[(CH₂)ₘ—O—]— group (NHS ester (like: progargyl-PEG5-NHS ester)+amino functionalized beads), —(CH₂)ₙ—NR³—(CH₂)ₚ—, wherein R³ is a hydrogen atom or a —(CH₂)_{q}—N[(CH₂)ᵣCOO(H)]₂ group (N-[(3-Trimethoxysilyl)propyl]ethylenediamine triacetic acid), and —(CH₂)ₙ—C₆H₄— group (C₆H₄: phenyl, Trimethoxy-(2-phenylethyl)-silan); wherein n, m, p, q and r are independently an integer selected from the range of from 2 to 10.

### 4^{th} Aspect—Process for Functionalizing a Magnetic Bead

A fourth aspect of the invention is related to a process for functionalizing a magnetic bead obtained or obtainable from the method of the first aspect as described above or according to the second aspect as described above comprising at least one magnetic particle (M) and a silica coating, wherein the silica coating comprises at least two silica layers, the process comprising
(A) providing a mixture comprising water and a magnetic bead comprising at least one magnetic particle (M) and a silica coating, wherein the silica coating comprises at least two silica layers;
(B) Adding a compound comprising a silane part and a functional group, which is capable of reacting with a hydroxyl group, and optionally a base, which comprises preferably ammonia, thereby obtaining a mixture comprising a magnetic bead comprising at least one magnetic particle (M) and a silica coating, wherein the silica coating comprises at least two silica layers and having one or more functional group(s) covalently bonded to its outer silica layer (functionalized magnetic bead);
(C) Optionally separating, preferably by magnetic separation, the functionalized magnetic bead from the mixture;
(D) Optionally resuspending the functionalized magnetic bead in water or alcohol, preferably in water or ethanol.

All details disclosed above in the sections related to the first aspect (method for preparing a magnetic bead comprising at least one magnetic particle (M) and a silica coating, wherein the silica coating comprises at least two silica layers) and the second aspect of the invention (magnetic bead comprising at least one magnetic particle (M) and a silica coating, wherein the silica coating comprises at least two silica layers) also apply with respect to the magnetic bead in the context of the fourth aspect.

5^{th} Aspect—Method for Preparing Magnetic Fe₃O₄ Supra Particles

A fifth aspect of the invention is directed to a method for preparing magnetic Fe₃O₄ supra particles comprising:
(a) Providing a mixture of an iron halide and a C2 to C5 diol;
(b) Combining the iron halide according to (a) with a mixture comprising at least sodium acetate and C2 to C5 diol, obtaining a mixture comprising iron halide, sodium acetate and C2 to C5 diol;
(c) keeping the mixture obtained in (b) at a temperature in the range of from 150 to 250° C., at a pressure in the range of from 2 to 20 bar, thereby obtaining a mixture comprising magnetic Fe₃O₄ supra particles.

According to an embodiment of the method for preparing magnetic Fe₃O₄ supra particles, the iron halide is iron(III)trichloride, preferably iron(III)trichloride in hydrated form, more preferably FeCl₃*6H₂O.

According to an embodiment of the method for preparing magnetic Fe₃O₄ supra particles, the mixture comprising at least sodium acetate (NaOAc) and C2 to C5 diol (EG) additionally comprises trisodium citrate (Na₃Cit) or polymer of a C2 to C5 diol (PEG) and the mixture obtained in (b) comprises iron halide, sodium acetate, trisodium citrate and C2 to C5 diol or iron halide, sodium acetate, polymer of a C2 to C5 diol and C2 to C5 diol.

According to an embodiment of the method for preparing magnetic Fe₃O₄ supra particles, (a) comprises
(a.1) combining an iron halide with C2 to C5 diol;
(a.2) mixing iron halide with C2 to C5 diol in the presence of an inert gas at a temperature in the range of from 10 to 40° C., preferably in the range of from 15 to 30° C., thereby obtaining a mixture of iron halide and C2 to C5 diol.

Preferably, step (c) is done in the presence of an inert gas. The inert gas is preferably selected from the group consisting of helium, neon, argon, krypton, radon, xenon, nitrogen and mixtures of two or more of these inert gases. Preferably, (c) is done at a temperature in the range of from 170 to 210° C., more preferably in the range of from 180 to 200° C. Preferably, (c) is done in a closed vessel, more preferably in an autoclave.

According to an embodiment of the method for preparing magnetic Fe₃O₄ supra particles, the C2 to C5 diol according to (a), and (a.1), (a.2) respectively, is ethylene glycol. According to an embodiment of the method for preparing magnetic Fe₃O₄ supra particles, the polymer of a C2 to C5 diol is a polymer of the C2 to C5 diol and is preferably poly ethylene glycol, which has preferably an average molecular weight in the range of from 1000 to 10000 g/mol, more preferably an average molecular weight in the range of from 1500 to 8000 g/mol, more preferably an average molecular weight in the range of from 2000 to 6000 g/mol, more preferably an average molecular weight in the range of from 3000 to 5000 g/mol.

According to an embodiment of the method for preparing magnetic Fe₃O₄ supra particles the method comprises:
(d) Cooling the mixture comprising magnetic Fe₃O₄ supra particles obtained in (c) to a temperature below 50° C., preferably below 40° C.;
(e) Separating magnetic Fe₃O₄ supra particles and washing the magnetic Fe₃O₄ supra particles at least twice, preferably at least three times, more preferably at least four times, more preferably at least five times, more preferably at least 6 times, each time followed by subsequent magnetic separation and resuspension in, preferably deionized, water.

### 6^{th} Aspect—Use of the Magnetic Bead or of the Functionalized Magnetic Bead

A sixth aspect of the invention is related to the use of a magnetic bead obtained or obtainable from the method of the first aspect as described above or according to the second aspect as described above or of the functionalized magnetic bead obtainaned or obtainable form the process of the third aspect of the invention as described above or of a functionalized magnetic bead according to the third aspect of the invention as described above for immobilization of acid stable biocatalysts (like acidophilic bacteria and archaea) or for solid-phase organic synthesis using acid-stable linker.

The present invention is further illustrated by the following embodiments and combinations of embodiments as indicated by the respective dependencies and back-references. In particular, it is noted that in each instance where a range of embodiments is mentioned, for example in the context of a term such as “The process of any one of embodiments 1 to 4”, every embodiment in this range is meant to be explicitly disclosed for the skilled person, i.e. the wording of this term is to be understood by the skilled person as being synonymous to “The process of any one of embodiments 1, 2, 3, and 4”.
1. A method for preparing a magnetic bead comprising at least one magnetic particle (M) and a silica coating, wherein the silica coating comprises at least two silica layers, the method comprising:
   (a) Providing at least one magnetic particle (M) having a first silica layer on its outer surface;
   (b) Dispersing the at least one magnetic particle (M) having a first silica coating on its outer surface according to (a) in an alcoholic solvent thereby obtaining a dispersion of the at least on magnetic particle (M) having a first silica layer on its outer surface;
   (c) Adjusting the pH of the dispersion obtained in (b) to a value of >7, thereby obtaining a basic dispersion of the at least one magnetic particle (M) having a first silica layer on its outer surface;
   (d) Adding a silica source to the dispersion of the at least one magnetic particle (M) having a first silica layer on its outer surface obtained in (c); thereby obtaining a dispersion comprising a magnetic bead comprising at least one magnetic particle (M) and a silica coating, wherein the silica coating comprises two silica layers;
   wherein at least one of steps (b), (c) and (d) is/are done under sonication, wherein sonication is done with an amplitude (peak-to-peak) in the range of from 50 to 250 μm.
2. The method of embodiment 1, wherein at least steps (b) and (c) and/or (d), more preferably steps (b), (c) and (d), is/are done under sonication, and/or wherein (ultra)sonication is done with an (ultra)sonic amplitude (peak-to-peak) in the range of from 90 to 180 μm, wherein (ultra)sonication is preferably done in an ultrasonic flow cell, preferably under continuous flow, more preferably under continuous flow with a flow rate in the range of from 100 to 1000 ml/min, preferably in the range of from 200 to 700 ml/min, more preferably in the range of from 400 to 600 ml/min.
3. The method of embodiment 1 or 2, comprising:
   (e) Separating a magnetic bead comprising at least one magnetic particle (M) and a silica coating, wherein the silica coating comprises two silica layers, preferably at least one magnetic particle (M) having a first silica layer on its outer surface and a second silica layer (directly) on the first silica layer, from the dispersion obtained in (d).
4. The method of any one of embodiments 2 to 3, further comprising
   (f) Providing at least on magnetic particle (M) having a first silica layer on its outer surface and a second silica layer (directly) on the first silica layer; and repeating the sequence of steps (b), (c), (d) and optionally (e) at least once, preferably in the range of from 1 to 8 times, more preferably in the range of from 1 to 6 times, more preferably in the range of from 1 to 3 times, hereby obtaining a magnetic bead comprising at least one magnetic particle (M) and a silica coating, wherein the silica coating comprises in the range of from 3 to 10, more preferably in the range of from 3 to 8, more preferably in the range of from 3 to 5, silica layers.
5. A magnetic bead comprising at least one magnetic particle (M) and a silica coating, wherein the silica coating comprises at least two silica layers, obtained or obtainable from the method according to any one of embodiments 1 to 4.
6. A magnetic bead comprising
   (iii) at least one magnetic particle (M) and
   (ii) a silica coating, wherein the silica coating comprises at least two silica layers;
   wherein the magnetic bead is stable against 7.5 M hydrochlorid acid and has a metal (cation) leaching rate in 7.5 M hydrochloric acid in the range of from 0.1 to 10%, wherein the metal (cation) leaching is determined according to a complex formation of Fe²⁺ with bathophenanthroline (4,7-phenylsulfonyl-1,10-phenanthroline) according to Reference Example 8.2.
7. The magnetic bead of embodiment 6, having a stability against acids, preferably against HCl, wherein the value of the magnetization of the magnetic bead after an acid treatment changes (preferably decreases) by less than 6%, preferably by less than 5.5%, more preferably by less than 5%, compared to the bead's magnetization before acid treatment, wherein the acid treatment is preferably a treatment with 7.5 M HCl for 30 minutes, preferably as in Reference Example 8.1.
8. The magnetic bead of embodiment 6 or 7, wherein the silica coating according to (ii) comprises in the range of from 2 to 10 silica layers, preferably in the range of from 2 to 8 silica layers, more preferably in the range of from 2 to 5 silica layers more preferably in the range of from 3 to 4 silica layers.
9. The magnetic bead of any one of embodiments 6 to 8, having an average particle size in the range of from 0.2 to 5 μm as determined according to Reference Example 3.1.
10. The magnetic bead of any one of embodiments 6 to 9, wherein each silica layer has an thickness in the range of from 10 to 40 nm, preferably determined based on a REM picture.
11. The magnetic bead of any one of embodiments 6 to 10, wherein the magnetization loss per layer is in the range of from 5 to 25 Am²/kg. per silica layer, determined according to Reference Example 1.
12. The magnetic bead of any one of embodiments 6 to 11 having a metal (cation) leaching rate, preferably an iron cation leaching rate, in 7.5 M hydrochloric acid in the range of from 0.5 to 5%, preferably <5% in case of two silica layers (i.e. after 2^{nd} coating with silica) and <1% in case of three silica layers (i.e. after the third coating with silica), wherein the metal (cation) leaching in 7.5 M hydrochloric acid is determined according to a complex formation of Fe²⁺ with bathophenanthroline according to Reference Example 8.2.
13. The magnetic bead of any one of embodiments 6 to 12, having a surface area in the range of from 30 to 300 m² per kg of the magnetic bead, determined according to Reference Example 5.
14. The magnetic bead of any one of embodiments 6 to 13, having a saturation magnetization of at least 25 A m² per kg of the magnetic bead, as determined according to Reference Example 1.
15. The magnetic bead of any one of embodiments 6 to 14, having a magnetic remanence of <3 A m² per kg of the magnetic bead, determined according to Reference Example 1.
16. The magnetic bead of any one of embodiments 6 to 15, having a stability against acids, preferably against HCl, wherein the value of the magnetic remanence of the magnetic bead after an acid treatment, changes (preferably decreases) by <100%, preferably by less than 50%, more preferably by less than 15%, compared to the bead's magnetic remanence before acid treatment, wherein the acid treatment is preferably a treatment with 7.5 M HCl for 30 minutes, preferably as in Reference Example 8.1.
17. A functionalized magnetic bead comprising at least one, magnetic bead according to embodiment 5 or according to any one of embodiments 6 to 16, wherein an outer silica layer is functionalized with at least one group selected from the group consisting of amino group, azide group, alkyne group, carboxyl group, thiol group, epoxy group, aryl group (aryl=preferably phenyl) and alkyl group (alkyl=preferably C2 to C20 alkyl group).
18. The functionalized magnetic bead of embodiment 17, wherein the functional group is bound to the outer silica layer by a structure element (I)

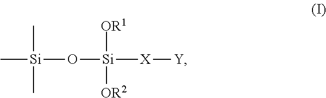

wherein
Si connected by three dotted lines represents a silicon atom in the outer silica layer;
R¹, R² are idependently selected from hydrogen atom, C1 to C5 alkyl group, preferably methyl group or ethyl group, and a bond to a further Silicon atom in the outer silica layer;
X represents a spacer group; and
Y represents a functional group selected from the group defined in embodiment 15.
19. The functionalized magnetic bead of embodiment 18, wherein the spacer group X is selected from the group consisting of C2 to C20 alkyne group (3-Azidopropyl-triethoxysilane, 11-Azidoundoundecyl-triethoxysilane, Carboxyethylsilanetriol, Trimethoxy-(octadecyl)-silan), which optionally has one or more substituents selected from hydrogen atom and —(CH₂)—COOH group (3-Triethoxysilyl)propylsuccinic anhydride), —(CH₂)ₙ—NH—C(═O)—[(CH₂)ₘ—O—]— group (Propargyl-PEG3-triethoxysilan), —(CH₂)ₙ—CH(OH)—CH₂—NH—[(CH₂)ₘ—O—]— group (2-[2-(2-propynyloxy)ethoxy]ethylamine)+epoxy functionalized beads), —(CH₂)ₙ—NH—C(═O)—[(CH₂)ₘ—O—]— group (NHS ester (like: progargyl-PEG5-NHS ester)+amino functionalized beads), —(CH₂)ₙ—NR³—(CH₂)ₚ—, wherein R³ is a hydrogen atom or a —(CH₂)_{q}—N[(CH₂)ᵣCOO(H)]₂ group (N-[(3-Trimethoxysilyl)propyl]ethylenediamine triacetic acid), and —(CH₂)ₙ—C₆H₄— group (C₆H₄: phenyl, Trimethoxy-(2-phenylethyl)-silan); wherein n, m, p, q and r are independently an integer selected from the range of from 2 to 10.
20. A process for functionalizing a magnetic bead according to embodiment 5 or according to any one of embodiments 6 to 16 comprising at least one magnetic particle (M) and a silica coating, wherein the silica coating comprises at least two silica layers, the process comprising
   (A) providing a mixture comprising water and a magnetic bead comprising at least one magnetic particle (M) and a silica coating, wherein the silica coating comprises at least two silica layers;
   (B) Adding a compound comprising a silane part and a functional group, which is capable of reacting with a hydroxyl group, and optionally a base, which comprises preferably ammonia, thereby obtaining a mixture comprising a magnetic bead comprising at least one magnetic particle
   (M) and a silica coating, wherein the silica coating comprises at least two silica layers and having one or more functional group(s) covalently bonded to its outer silica layer (functionalized magnetic bead);
   (C) Optionally separating, preferably by magnetic separation, the functionalized magnetic bead from the mixture;
   (D) Optionally resuspending the functionalized magnetic bead in water or alcohol, preferably in water or ethanol.
21. A method for preparing magnetic Fe₃O₄ supra particles comprising:
   (a) Providing a mixture of an iron halide and a C2 to C5 diol;
   (b) Combining the iron halide according to (a) with a mixture comprising at least sodium acetate and C2 to C5 diol, obtaining a mixture comprising iron halide, sodium acetate and C2 to C5 diol;
   (c) keeping the mixture obtained in (b) at a temperature in the range of from 150 to 250° C., at a pressure in the range of from 2 to 20 bar, thereby obtaining a mixture comprising magnetic Fe₃O₄ supra particles.
22. The method for preparing magnetic Fe₃O₄ supra particles according to embodiment 21, wherein the iron halide is iron(III)trichloride, preferably iron(III)trichloride in hydrated form, more preferably FeCl₃*6H₂O.
23. The method for preparing magnetic Fe₃O₄ supra particles according to embodiment 21 or 22, wherein the mixture comprising at least sodium acetate (NaOAc) and C2 to C5 diol (EG) additionally comprises trisodium citrate (Na₃Cit) or polymer of a C2 to C5 diol (PEG) and the mixture obtained in (b) comprises iron halide, sodium acetate, trisodium citrate and C2 to C5 diol or iron halide, sodium acetate, polymer of a C2 to C5 diol and C2 to C5 diol.
24. The method for preparing magnetic Fe₃O₄ supra particles according to any one of embodiments 21 to 23, wherein (a) comprises
   (a.1) combining an iron halide with C2 to C5 diol;
   (a.2) mixing iron halide with C2 to C5 diol in the presence of an inert gas at a temperature in the range of from 10 to 40° C., preferably in the range of from 15 to 30° C., thereby obtaining a mixture of iron halide and C2 to C5 diol.
25. The method for preparing magnetic Fe₃O₄ supra particles according to any one of embodiments 21 to 24, wherein (c) is done in the presence of an inert gas.
26. The method for preparing magnetic Fe₃O₄ supra particles according to any one of embodiments 21 to 25, wherein (c) is done at a temperature in the range of from 170 to 210° C., preferably in the range of from 180 to 200° C.
27. The method for preparing magnetic Fe₃O₄ supra particles according to any one of embodiments 21 to 26, wherein (c) is done in a closed vessel, preferably in an autoclave.
28. The method for preparing magnetic Fe₃O₄ supra particles according to any one of embodiments 21 to 27, wherein the C2 to C5 diol is ethylene glycol.
29. The method for preparing magnetic Fe₃O₄ supra particles according to any one of embodiments 21 to 28, wherein the polymer of a C2 to C5 diol is a polymer of the C2 to C5 diol and is preferably poly ethylene glycol, which has preferably an average molecular weight in the range of from 1000 to 10000 g/mol, more preferably an average molecular weight in the range of from 1500 to 8000 g/mol, more preferably an average molecular weight in the range of from 2000 to 6000 g/mol, more preferably an average molecular weight in the range of from 3000 to 5000 g/mol.
30. The method for preparing magnetic Fe₃O₄ supra particles according to any one of embodiments 21 to 29, comprising:
   (d) Cooling the mixture comprising magnetic Fe₃O₄ supra particles obtained in (c) to a temperature below 50° C., preferably below 40° C.;
   (e) Separating magnetic Fe₃O₄ supra particles and washing the magnetic Fe₃O₄ supra particles at least twice, preferably at least three times, more preferably at least four times, more preferably at least five times, more preferably at least 6 times, each time followed by subsequent magnetic separation and resuspension in, preferably deionized, water.
31. Use of a magnetic bead according to any one of embodiments 5 or 6 to 16 or of a functionalized magnetic bead according to any one of embodiments 17 to 19 for immobilization of acid stable biocatalysts (like acidophilic bacteria and archaea) or for solid-phase organic synthesis using acid-stable linker.

### EXAMPLES

The following Examples shall merely illustrate the invention. Whatsoever, they shall not be construed as limiting the scope of the invention.

Analytic method are described in the following in Reference Examples 1 to 9.

### Reference Example 1 Magnetization and Magnetic Remanence

Magnetic properties of the particles were measured using a Lake Shore VMS 7404-S fully integrated vibrating sample magnetometer (VSM). In this method, a magnetic material was vibrated within a uniform magnetic field, H, inducing an electric current in suitably placed sensing coils. The resulting voltage induced in the sensing coils was proportional to the magnetic moment of the sample. The Lake Shore VMS 7404 recorded hysteresis curves (see as an example FIG. 1), from where the magnetic properties of the sample were deduced. The measurements were conducted according to the manual (version 2.5).

### Reference Example 2 Mass Concentration

The mass concentration was determined using gravimetric analysis. Therefore, first four empty 2 ml Eppendorf cups were weighed. Then 0.5 ml of the final suspension was pipetted into each cup, the particles were separated using a magnet and the supernatant was removed. Finally, the particles were washed once with ethanol by resuspension and subsequent magnetic separation. After drying overnight, the cups containing the dried magnetic particles were weighed again.

The mass was calculated for each cup from the mass difference between full and empty cup. The mass concentration [mg/ml] was calculated from the average mass of all four cups [mg] divided by the used suspension volume [ml].

### Reference Example 3 Determination of Size

### 3.1 Size—Dynamic Light Scattering (DLS)

The size of the magnetic particles was measured using a Malvern Zetasizer nano-ZS instrument. Dynamic Light Scattering (DLS) is a technique classically used for measuring the hydrodynamic radius of particles dispersed in a liquid. DLS measured Brownian motion and related this to the size of the particles. Brownian motion was the random movement of particles in a solvent. The larger the particle or molecule, the slower the Brownian motion. Smaller particles moved more rapidly. The velocity of the Brownian motion was defined by the translational diffusion coefficient. The size of a particle was calculated from the translational diffusion coefficient by using the Stokes-Einstein equation.

For a typical measurement, 1 μl of the magnetic particle solution (concentration 26 mg/ml) was diluted with 1 ml of filtered MilliQ grade water and placed in the instrument. The measurement were conducted according to the manual (version 3.1).

### 3.2 Size Distribution—Horiba

The size distribution of the magnetic particles in suspension was measured using a Horiba Laser Scattering Particle Size Distribution Analyzer LA-960. Thereby, the distribution was measured by static light scattering. The interaction of laser light with particles of a certain size resulted in a characteristic scattering pattern, induced by diffraction, refraction, reflection and absorption. The size distribution was calculated based on the Fraunhofer- and the Mie-Theory. An exemplary measurement is shown in FIG. 3. The measurements were conducted according to the manual (version 1).

### Reference Example 4 Isoelectric Point (IEP)

The IEP of the magnetic particles was measured using a Malvern Zetasizer nano-ZS instrument. The IEP is the pH value where the zeta potential is zero. The IEP was determined by titrating the sample (from high to low pH values) and recording zeta potential as a function of pH. The samples were measured at a concentration of 0.5 mg/ml in 10 mM NaCl. An exemplary titration curve is shown in FIG. 4. The measurements were conducted according to the manual (version 4).

### Reference Example 5 Surface Area

The BET (Brunauer-Emmett-Teller) surface area of magnetic particles was measured using a Quantachrome Autosorb-iQ-C instrument using Nitrogen gas as adsorbent at a temperature of 77 K (=boiling point of N2). The BET theory aims to explain the physical adsorption of gas molecules on a solid surface and serves as the basis for an important analysis technique for the measurement of the specific surface area of materials. The observations are very often referred to as physical adsorption or physisorption. The measurements were conducted according to the manual (version 5.0).

### Reference Example 6 Scanning Electron Microscope (SEM)

Scanning electron microscope (SEM) images were recorded using a Zeiss Supra 55VP. A SEM is a type of electron microscope that produces images of a sample by scanning the surface with a focused beam of electrons. The electrons interact with atoms in the sample, producing various signals that contain information about the surface topography and composition of the sample.

The sample in high dilution in EtOH was applied on a silicon wafer. Prior to the measurements, the samples were sputtered with a thin film of platinum.

### Reference Example 7 Quantification of Functional Groups

### 7.1 COOH Quantification

Carboxyl groups on the bead's surface were quantified by complexation with Ni²⁺. Whereas the amount of non-bound Ni²⁺ is quantified photometrically by the formation of a complex with pyrocatechol violet (PV), which has a high absorption at 650 nm. The amount of carboxyl groups was calculated by an empirical formula. This principle of quantification was established by Henning et al.[18].

The beads were dispersed in HEPES buffer (10 mM, pH 7.4) with a concentration of 50 mg/ml. 50 to 300 μl of the beads were diluted with HEPES buffer to 300 μl, then a Ni(ClO₄)₂ solution (400 μM, 300 μl) was added. After 2 minutes, the beads were magnetically separated and 0.5 ml of the supernatant was added to 0.5 ml of a PV solution (80 μM in HEPES buffer). The sample was immediately measured by UV-Vis spectroscopy at 650 nm. For the calculation, also the absorption of 0.5 ml PV solution diluted with HEPES buffer (0.5 ml) was measured.

The absorption at 650 nm was plotted in a diagram versus the used volume of beads. An exemplary diagram is shown in FIG. 6 for COOH-3-functionalized beads.

The linear part was extrapolated and the slope (a) and the intercept (b) were used for the calculation of the amount of carboxyl group according to formula (1).

$$surface COOH - groups ( \frac{μ mol}{g} ) = \frac{n [ {M}^{2 +} ] Va}{w ( {A}_{PV} - b )} \qquad ( 1 )$$

n is a stoichiometric factor with the value 2.65, which indicates the number of carboxyl groups per nickel cation. [M²⁺] is the concentration of Ni²⁺ ions in volume V during incubation with the particles. w is the mass concentration of the particles in mg/ml. A_{PV} is the absorption of PV diluted with HEPES buffer.

### 7.2 Azido/Alkyne Quantification

For the quantification of alkyne or azido groups on the bead's surface a click reaction with an Fmoc protected amino acid was performed. Fmoc-β-azido-Ala-OH was used for the quantification of alkyne groups and for azido groups Fmoc-Pra-OH was used. By cleaving the protection qroup with piperidine a Fulven adduct was formed which was spectrometrically quantified.

A premix of Cu(I)Br (0.1 M) and Tris((1-benzyl-4-triazolyl)methyl)amine (0.1 M) in a ratio of 1:2 was produced. 5 mg Beads were washed with DMF, the premix (300 μl) and the Fmoc protected amino acid (200 μl, 0.1 M) were added to the beads. The reaction was performed at 40° C. for 3 h in a thermo shaker at 1000 rpm. Afterwards, the beads were separated by a magnet, washed 3 times with DMF (0.5 ml) and DMSO (0.5 ml) and once more with DMF. To the beads a mixture of 20% piperidine in DMF (0.5 ml) was added. The beads were shaken at room temperature for 15 min (1000 rpm). This step was repeated and the supernatants were merged.

The absorption of the merged supernatants was measured at 301 nm, whereas 20% Piperidine in DMF was used as the background.

The amount of formed Fulven adduct was calculated according to Beer's Law (2), where A is the measured absorption, e the molar extinction coefficient of the Fulven adduct (e=7800 L mol⁻¹ cm⁻¹), c the concentration in mol/L and d is the optical path length in cm.

$$A = ε \cdot c \cdot d \qquad ( 2 )$$

The amount of the Fulven adduct corresponds to the amount of functional groups on the bead's surface.

### Reference Example 8 HCl Stability and Iron Leakage

### 8.1 HCl Stability

The beads (30 mg) were dispersed in H₂O (1 ml) and HCl (8 M, 10 ml) was added. The beads remained in this mixture for 30 min. For stopping the procedure, the beads were separated magnetically, the supernatant was used for the measurement of the iron leakage and the beads were washed several times with water until the pH was neutral. After the HCl treatment, the beads were characterized by magnetization, IEP and their amount of functional groups.

8.2 Iron leakage

The amount of iron in the supernatant after the HCl stability test was quantified by using 4-(Methylamino)phenol sulfate for the reduction of Fe³⁺ to Fe²⁺. Fe²⁺ forms a red complex with bathophenanthroline disulfonic acid disodium salt, which was has a high absorption at 546 nm.

A bathophenanthroline solution was prepared: NaOAc (24.4 g) was dissolved in H₂O, acetic acid (100%, 10.6 ml) was added and it was diluted with H₂O to 85 ml. Bathophenanthroline disulfonic acid disodium salt (27 mg in 2 ml H₂O), 4-(Methylamino)phenol sulfate (170 mg) and Sodium metabisulfite (1.7 g) was added and the solution was diluted to 90 ml with H₂O.

An iron standard solution was prepared by dissolving Iron(II) sulfate (497.8 mg) in HCl (0.1 M, 100 ml). For the measurement the solution was diluted 1:1000 with H₂O, resulting in concentration on 1 μiron/ml.

The supernatant was diluted 1:7.2 to end up with a 1 M HCl. Then the sample was diluted 1:10 or 1:100. To 1 ml of the diluted sample, the diluted iron standard and water (as the blank) HCl (1 M, 1 ml) and the Bathophenanthroline solution (1 ml) was added. After 20 min the Adsorption was measured at 546 nm. The iron content was calculated from the absorption values according to formula (3)

$$iron content [ μ g / mL ] = \frac{( {A}_{supernatant} - {A}_{blank} )}{( {A}_{standard} - {A}_{blank} )} \qquad ( 3 )$$

### Reference Example 9 UV Vis Spectroscopy

UV-Vis spectroscopy measurements for the alkyne and azido quantification were performed at a Lambda 25 UV Vis spectrometer with the software UV WinLab V 2.85.04 The measurements were conducted with a quartz cuvette (Hellma Analytics) at 301 nm, according to the manual (Version 2.0). The solvent (20% Piperidine in DMF) was used for a background measurement.

A Cary 60 UV-Vis spectrophotometer with the software Cary WinUV was used for the quantification of carboxyl groups and the amount of iron leakage. The samples were prepared in single-use semi-micro UV-cuvettes (Brand) The measurements were conducted according to the manual. For the carboxyl quantification, the Advanced Reads was used at 650 nm. The iron leakage was measured at 546 nm. The according solvents were used for background corrections.

### Reference Example 10 Solvothermal Core Synthesis

### 1.1 Na₃Cit/NaOAc Synthesis Route

Magnetic Fe₃O₄ supra particles (core particles) were synthesized by the reduction of FeCl₃*6H₂O in the presence of a mixture of Na₃Cit/NaOAc in ethylene glycol (EG) at 200° C. and at increased pressure of 2-10 bar. The formed spherical agglomerates consist of ultrasmall individual Fe₃O₄-NPs. The physical-chemical properties of the synthesized particles strongly depends on the used equivalents of FeCl₃*6H₂O, Na₃Cit and NaOAc and the amount of solvent (EG). Reaction conditions and analytical data are summarized in Table 2.

The general manufacturing procedure was always identical. Iron chloride was dissolved in ethylene glycol under magnetic stirring and inert conditions (Argon) at room temperature for at least 30 min. Afterwards the dissolved iron chloride/ethylene glycol solution was transferred into an autoclave and Na₃Cit and NaOAc were added. The autoclave was closed and the solution was stirred for a few minutes using a KPG stirrer to homogenize the suspension. After inertization with argon, the autoclave was hermetically sealed and the heating program (see Table 1) was started. After the synthesis program was completed, the reactor was actively cooled using water (room temperature). As soon as the reaction cooled down below 40° C., the reactor was opened and the final black product suspension was washed at least 6 times by subsequent magnetic separation and resuspension in deionized water.

TABLE 1
Heating program for solvothermal Na₃Cit/NaOAc synthesis

| Step No. | Target Temperatur [° C.] | Time (h:min) |
|---|---|---|
| 1 | 180 | 2:30 |
| 2 | 200 | 1:00 |
| 3 | 200 | 18:00 |
| 4 | 10 | 10:00 |

TABLE 2
Core particles synthesized using the Na₃Cit/NaOAc route.

| | Synthesis conditions | | | | Analytics | | |
|---|---|---|---|---|---|---|---|
| No. | Na₃Cit | NaOAc | FeCl₃ * 6H₂O | EG | Magnetization | Remanence | BET |
| Bead | [Eq¹] | [Eq¹] | [mmol] | [ml] | [Am²/kg] | [Am²/kg] | [m²/g] |
| 1 | 0.5 | 4 | 163 | 800 | 57 | 0.83 | 135 |
| 2 | 0.3 | 3 | 244.5 | 800 | 59.5 | 0.96 | 136 |
| 3 | 0.5 | 2 | 326 | 800 | 59.4 | 2.13 | 97 |
| 4 | 0.1 | 4 | 326 | 800 | 62.3 | 2.76 | 130 |
| 5 | 0.1 | 2 | 163 | 800 | 66.6 | 3.75 | 114 |
| 6 | 0.1 | 2 | 326 | 800 | 64.1 | 2.82 | 131 |
| 7 | 0.5 | 4 | 326 | 800 | 69.5 | 5.32 | 84 |
| 8 | 0.5 | 2 | 163 | 800 | 36 | 0.3 | 174 |
| 9 | 0.1 | 4 | 163 | 800 | 65.7 | 1.37 | 130 |
| 10 | 0.5 | 6 | 163 | 800 | 70.7 | 2 | 84 |
| 11 | 0.3 | 5 | 244.5 | 800 | 71.2 | 1.6 | 63 |
| 12 | 0.1 | 6 | 326 | 720* | 79.1 | 4.5 | 50 |
| 13 | 0.5 | 6 | 326 | 700* | 84 | 19.3 | 24 |
| 14 | 0.1 | 6 | 163 | 800 | 72 | 2.7 | 98 |

*Volume reduced to avoid overflowing of the reactor, ¹Equivalents to FeCl₃*6H₂O in [mmol].

### 1.2 NaOAc/PEG Synthesis Route

Magnetic Fe₃O₄ supra particles (core particles) were synthesized by the reduction of FeCl₃*6H₂O in the presence of a mixture of NaOAc/PEG in ethylene glycol (EG) at 180-200° C. and at increased pressure of 2-15 bar. The formed spherical agglomerates consist of ultrasmall individual Fe₃O₄-NPs.

The general manufacturing procedure was identical to the Na₃Cit/NaOAc route described above in section 1.1. Iron chloride was dissolved in EG and mixed with NaOAc and PEG. After inertization with argon, the autoclave was hermetically sealed and the heating program (see Table 4) was started. After the synthesis program was completed, the final back product suspension was washed at least 6 times by subsequent magnetic separation and resuspension in deionized water.

The physical-chemical properties of the synthesized particles strongly depends on the used equivalents of FeCl₃*6H₂O and the reaction temperature. Reaction conditions and analytical data are summarized in Table 3.

TABLE 3
Core particles synthesized using the NaOAc/PEG route

| | Reaction conditions | | | | | | Analytics | | |
|---|---|---|---|---|---|---|---|---|---|
| | | | | | | Reac- | Magneti- | | |
| Bead | PEG | NaOAc | FeCl₃ | EG | Temp. | tion | zation | Remanence | BET |
| No. | [g] | [g] | [g] | [ml] | [° C.] | time [h] | [Am²/kg] | [Am²/kg] | [m²/g] |
| 1 | 36 | 130 | 48.6 | 720 | 200 | 12 | 86.4 | 17.9 | 19 |
| 2 | 18 | 65 | 24.3 | 720 | 200 | 20 | 81.0 | 15.3 | 39 |
| 3 | 18 | 65 | 24.3 | 720 | 180 | 20 | 76.3 | 7.2 | 67 |

TABLE 4
Heating program for solvothermal NaOAc/PEG synthesis

| Step No. | Target Temperature [° C.] | Time (h:min) |
|---|---|---|
| 1 | 180 | 2:30 |
| 2 | 180-200* | 1:00 |
| 3 | 180-200* | 10-20:00 |
| 4 | 10 | 10:00 |

*depending on synthesis conditions

### Example 1 Silica Coating

The magnetic core particles were coated with silica using tetraethyl orthosilicate (TEOS) as silica source in a basic alcohol/water mixture. Therefore, 10 g core particles were dispersed in a mixture of 1 L ethanol/water (3:1) using a KPG stirrer. Afterwards 12.5 ml TEOS and 12.5 ml ammonia were added slowly to initiate the coating reaction. The reaction was stirred for 6 h at room temperature (22° C.). To avoid agglomeration during the coating reaction, the whole reaction solution was continuously pumped through an ultrasonic flow cell (flow rate: 500 ml/min) using a tube pump und sonicated with an ultrasonic amplitude of 90-175 μm (peak-to-peak). A homogenisator (Hielscher up200st) with a S26d7D sonotrode was used, the flow cell had a volume of 15 ml. The reaction was stopped by washing the particles by subsequent magnetic separation and resuspension in deionized water. By varying the amount of TEOS, the shell thickness could be influenced.

It could be seen that one step coated beads were already stable in HCl, however they showed a higher iron loss (>5%) compared to multishell beads.

Two to five subsequent coating layers were necessary to achieve an acceptable chemical stability towards acids, while maintaining high magnetization and low magnetic remanence. The stability towards acids increased with each coating step. This can be seen by comparing the magnetization of the particles before and after 30 min in HCl. For unstable beads, the magnetization decreased after 30 min in HCl. Additionally the iron leakage was quantified by UV-Vis (see Table 5 and Table 6). However, also the particle agglomeration increased with each coating step (see size values in Table 5). This increase was not only due to an increased Si-shell thickness, but also due to agglomeration of the particles during the coating process. Silica acted like a shell to “glue” multiple supra-particles together (see electron microscopy images in FIG. 7 vs. FIG. 8). The effect was amplified with an increasing number of coating steps.

The undesired effect of agglomeration within the coating process could be reduced by using sonication. The resulting particles are smaller in their hydrodynamic diameter (see Table 5). Also less agglomerates could be observed in the SEM images (see FIG. 7).

The colloidal stability is visible to the naked eye by comparing core-shell particles synthesized with and without sonication (see FIG. 8). The colloidal stability, which strongly depends on the size of the particles is crucial for automatization not only within the final devices, but also in reagent filling and handling.

TABLE 5
Physical chemical properties of core-shell particles
with 1-5 silica layers (without sonication)

| | | | | | Magnetic | |
|---|---|---|---|---|---|---|
| Number | | | | Magnetization | Remanence | |
| of | | Magneti- | Magnetic | [Am²/kg] | [Am²/kg] | Iron |
| Coating | Size | zation | Remanence | after 30 min | after 30 min | leakage |
| Steps | [nm] | [Am²/kg] | [Am²/kg] | in 7.5M HCl | in 7.5M HCl | [%] |
| — | 255 | 56 | 1.2 | — | — | 100% |
| 1 | —* | 39.0 | 0.62 | 20.3 | 0.33 | 12.13 |
| 2 | —* | 30.0 | 0.48 | 27.8 | 0.47 | 0.088 |
| 3 | —* | 19.5 | 0.33 | 20.2 | 0.35 | 0.024 |
| 4 | —* | 16.3 | 0.29 | 16.8 | 0.30 | 0.021 |
| 5 | —* | 14.8 | 0.26 | 15.7 | 0.27 | 0.020 |

*due to agglomeration too polydispers for DLS measurements.

TABLE 6
Physical chemical properties of core-shell particles
with 1-5 silica layers (with sonication)

| | | | | Magne- | Magnetic | |
|---|---|---|---|---|---|---|
| Number | | | | tization | Remanence | |
| of | | Magneti- | Magnetic | [Am²/kg] | [Am²/kg] | Iron |
| Coating | Size | zation | Remanence | after 30 min | after 30 min | leakage |
| Steps | [nm] | [Am²/kg] | [Am²/kg] | in 7.5M HCl | in 7.5M HCl | [%] |
| — | 255 | 56 | 1.2 | — | — | 100 |
| 1 | 442 | 41.4 | 0.26 | 38.7 | 0.65 | 5.04 |
| 2 | 453 | 30.0 | 0.44 | 29.6 | 0.49 | 0.37 |
| 3 | 592 | 21.1 | 0.31 | 21.2 | 0.33 | 0.08 |
| 4 | 572 | 16.1 | 0.23 | 16.0 | 0.24 | 0.03 |
| 5 | 677 | 12.0 | 0.12 | 12.0 | 0.18 | 0.01 |

Even after 10 days in 7.5 M HCl, the particles survived and did not dissolve. SEM Images before and after 10 days in HCl are shown in FIG. 10.

### Example 2 Functionalization

### 2.1 Overview

Silica-coated magnetic nanoparticles were functionalized with various functional groups due to the existence of abundant silanol groups on the silica surface. The reaction conditions are summarized in

Table 7. Therefore the silica-coated particles were dispersed in MilliQ water or a water/solvent mixture. Then the functional silane and if required ammonia was added. The reaction was stirred during the whole reaction using either a KPG stirrer or a roller mixer. The reaction was stopped by washing the particles by subsequent magnetic separation and resuspension in deionized water (hydrophilic beads) or ethanol (hydrophobic beads).

TABLE 7
reaction conditions for functionalization

| | | | | | | | | | | Reaction |
|---|---|---|---|---|---|---|---|---|---|---|
| Funct. | Beads | Water | EtOH | | Silane | | | NH₃ | Reaction | Temp. |
| Group | [g] | [ml] | [ml] | Silane | [mmol] | Silane | | [ml] | time [h] | [° C.] |
| N₃-1 | 0.5 | 10 | — | 3-Azidopropyl- | 0.79 | 0.2 | ml | — | 24 | 22 |
| | | | | triethoxysilane | | | | | | |
| N₃-2 | 0.5 | 10 | — | (11-az-idoundecyl)tri- | 0.55 | 0.2 | g | — | 24 | 22 |
| | | | | ethoxysilane | | | | | | |
| COOH-1 | 0.5 | 40 | — | N-[(3-Tri- | 0.8 | 0.65 | ml | — | 24 | 22 |
| | | | | methoxysilyl) | | | | | | |
| | | | | propyl]eth- | | | | | | |
| | | | | ylenediamine | | | | | | |
| | | | | triacetic acid | | | | | | |
| | | | | 45% in water | | | | | | |
| COOH-2 | 0.5 | 40 | — | Carboxyeth- | 1.8 | 1.2 | ml | — | 24 | 22 |
| | | | | ylsilanetriol, | | | | | | |
| | | | | disodium salt; | | | | | | |
| | | | | 25% in water | | | | | | |
| COOH-3 | 10.5 | 40 | — | 3-Triethoxysi- | | 0.5 | ml | — | 24 | \|22 |
| | | | | lyl) propylsuc- | 1.75 | | | | | |
| | | | | cinic anhydride | | | | | | |
| C18 | 0.5 | 10 | 40 | Trimethoxy-(2- | | 0.5 | ml | 0.5 | 8 | 45 |
| | | | | phenylethyl)- | 2.28 | | | | | |
| | | | | silan | | | | | | |
| Phenyl | 0.5 | 10 | 40 | Trimethoxy- | 1.18 | 0.5 | ml | 0.5 | 18 | 45 |
| | | | | (octadecyl)- | | | | | | |
| | | | | silan | | | | | | |
| NH₂-1 | 0.5 | 100 | 250l | 3-Aminopropyl- | 5.34 | 1.25 | ml | 1.25 | 24 | 22 |
| | | | | triethoxysilan | | | | | | |
| NH₂-2 | 0.5 | 100 | 250 | 3-Aminopropyl- | 10.68 | 2.5 | ml | 2.5 | 24 | 22 |
| | | | | triethoxysilan | | | | | | |
| NH₂-3 | 0.5 | 75 | 250 | 3-Aminopropyl- | 10.68 | 2.5 | ml | 2.5 | 7 | 22 |
| | | | | triethoxysilan | | | | | | |

### 2.2 Stability

The stability of the functional groups was shown by different methods. For amino-functionalized beads, the isoelectric point (IEP) of the beads was a good indicator for the introduction of functional groups. The IEP shifted from 2.4 to about 6.5-8 after functionalization with NH₂. In case the amino groups were not stable towards HCl, the IEP should have shifted back to its initial value after HCl treatment. As this was not the case (see table 8), it could be concluded that the waste majority of the functional groups did “survive” the acid treatment. Small shifts of the IEP were most likely due to the measurement method, as it was difficult to adjust the pH accurately in the neutral region. The data are summarized in Table 8.

TABLE 8
Physical chemical properties of core-shell particles with 5
silica layers functionalized with acid stable amino-groups.

| | | | | | Magneti- | Magnetic | |
|---|---|---|---|---|---|---|---|
| | | | | | zation | Remanence | |
| | | Magneti- | Magnetic | IEP | [Am²/kg] | [Am²/kg] | Iron |
| Bead | | zation | Remanence | after 30 min | after 30 min | after 30 min | leakage |
| Lot | IEP | [Am²/kg] | [Am²/kg] | in 7.5M HCl | in 7.5M HCl | in 7.5M HCl | [%] |
| Reference | 2.40 | 12.0 | 0.12 | — | 12.0 | 0.18 | 0.01 |
| NH₂-1 | 7.87 | 11.9 | 0.18 | 8.21 | 12.3 | 0.19 | 0.01 |
| NH₂-2 | 7.60 | 12.2 | 0.18 | 7.17 | 12.2 | 0.19 | 0.009 |
| NH₂-3 | 6.73 | 12.1 | 0.19 | 7.26 | 11.8 | 0.18 | 0.05 |

The stability of other hydrophilic functional groups like alkyne, azide or carboxyl groups could be shown by spectrometric absorbance measurements. For azide and alkyne quantification new custom analytical methods were developed, which are based on the chemical binding of a cleavable group to the corresponding functional group, followed by quantification of the cleaved group using UV-Vis measurements. The carboxyl groups were quantified by a method based on a method of Ni²⁺ complexation developed by Henning et al. [18].

The stability of hydrophobic functional coatings could be proven by a hydrophobicity test. In a mixture of water and cyclohexane two phases were formed due to the immiscibility of these solvents. In these two phases hydrophilic particles remained in the aqueous phase at the bottom, while hydrophobic beads (with phenyl- or alkane-coatings) transfered into the upper organic phase. If the hydrophobic groups would be unstable in hydrochloric acid, it would have been expected that the beads transfer back into the aqueous phase after the HCl treatment. As this was not the case, it was concluded that the majority of the functional groups did “survive” the acid treatment (see Table 9 and FIG. 11).

TABLE 9
Physical chemical properties of core-shell particles with 5
silica layers functionalized with acid stable amino-groups.

| | | | | Functional | Magneti- | Magnetic | |
|---|---|---|---|---|---|---|---|
| | | | | Groups | zation | Remanence | |
| | Functional | Magneti- | Magnetic | [μmol/g] | [Am²/kg] | [Am²/kg] | Iron |
| Bead | Groups | zation | Remanence | after 30 min | after 30 min | after 30 min | leakage |
| Lot | [μmol/g] | [Am₂/kg] | [Am²/kg] | in 7.5M HCl | in 7.5M HCl | in 7.5M HCl | [%] |
| Reference | — | 29.1 | 1.50 | — | 28.0 | 1.17 | 0.29 |
| N₃-1 | 27 | 29.2 | 1.38 | 21 | 28.9 | 1.17 | 0.27 |
| N₃-2 | 35 | 30.0 | 1.41 | 23 | 27.9 | 1.11 | 0.21 |
| COOH-1 | 5 | 29.3 | 1.37 | 10 | 29.9 | 1.22 | 1.23 |
| COOH-2 | 4 | 33.5 | 1.50 | 9 | 33.3 | 1.27 | 3.71 |
| COOH-3 | 9 | 30.5 | 1.33 | 9 | 28.33 | 1.15 | 0.25 |
| Alkyne-1 | 14 | 29.4 | 1.28 | 13 | 32.5 | 1.47 | 0.75 |
| Alkyne-2 | 0.4 | 29.9 | 1.37 | 0.4 | 32.85 | 1.38 | 1.58 |
| Alkyne-3 | 2.5 | 29.05 | 1.22 | 2.3 | 30.53 | 1.25 | 0.08 |
| Phenyl | hydro- | 29.6 | 1.37 | hydro- | 27.9 | 1.27 | 0.24 |
| | phobic | | | phobic | | | |
| C18 | hydro- | 25.6 | 1.15 | hydro- | 25.5 | 1.13 | 0.18 |
| | phobic | | | phobic | | | |

### SHORT DESCRIPTION OF FIGURES

FIG. 1 shows Hysteresis curves recorded on a Lake Shore VMS 7404 using the software IDEAS V SM (version 4).

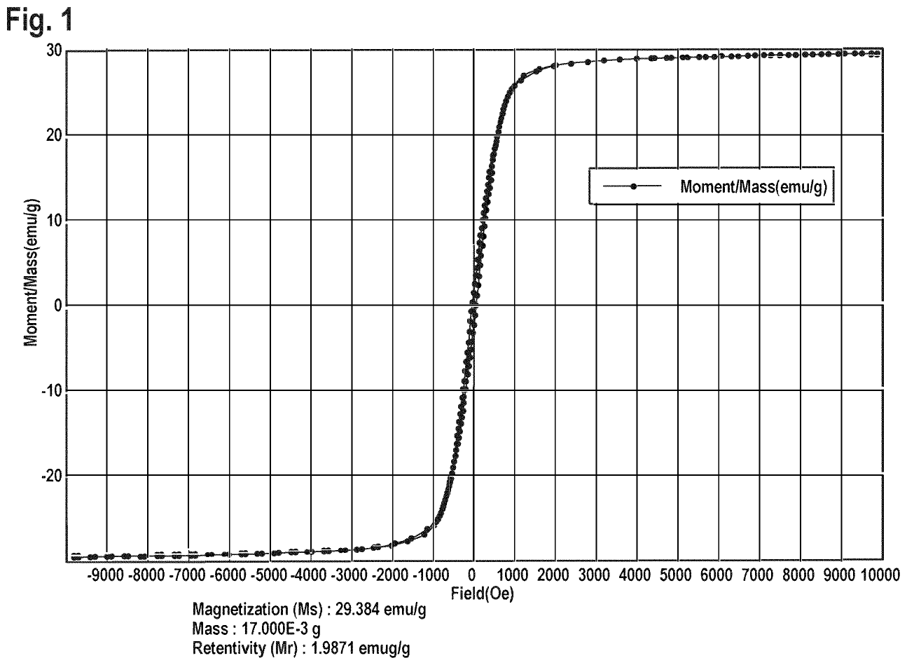

FIG. 2 shows a typical DLS measurement using a Malvern Zetasizer nano-ZS.

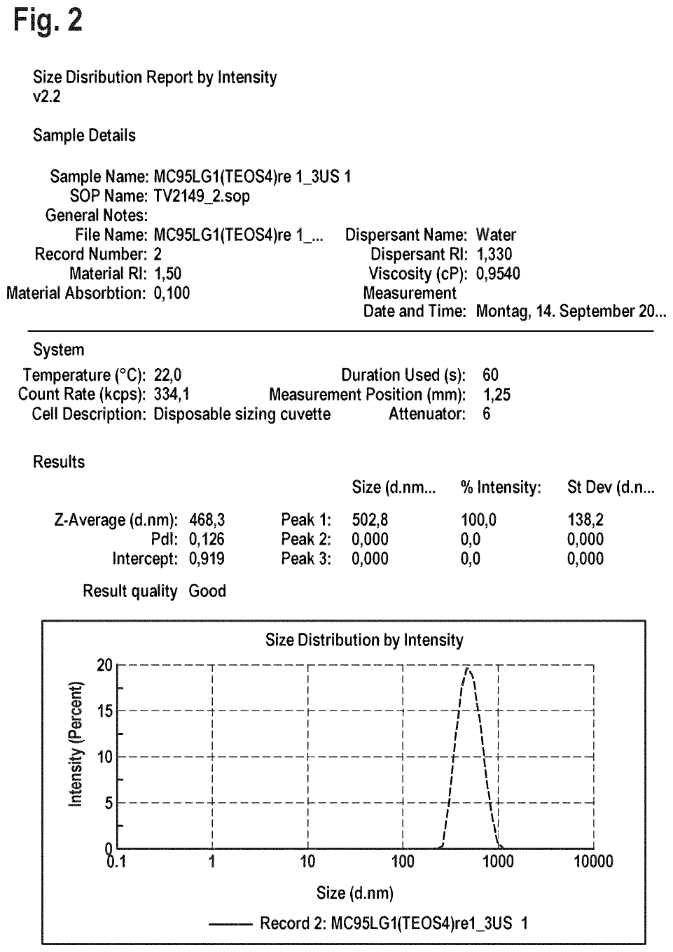

FIG. 3 shows a typical size distribution measurement using a Horiba LA-960.

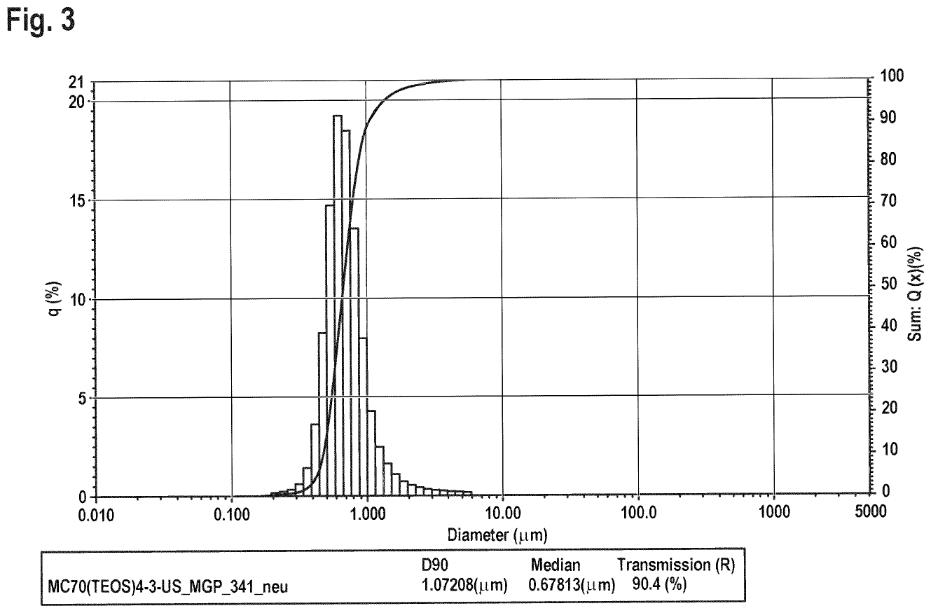

FIG. 4 shows a Titration curve recorded using a Malvern Zetasizer nano-ZS.

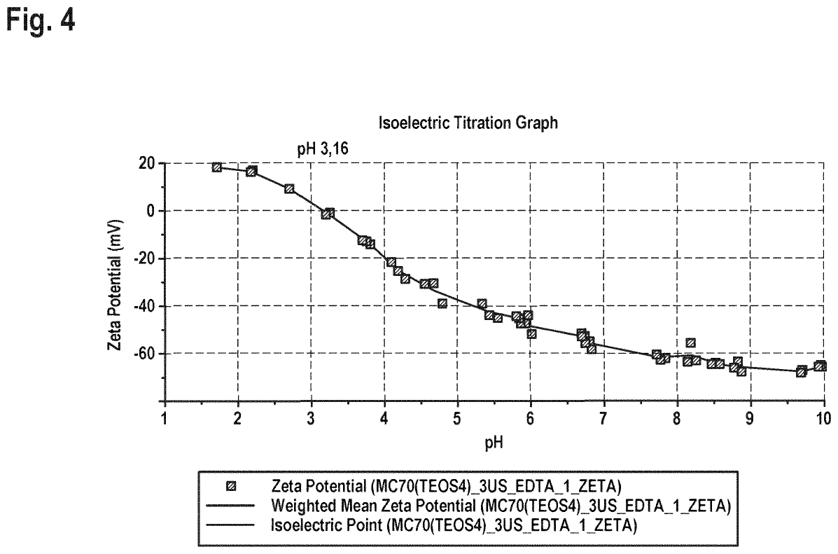

FIG. 5 shows autosorb iQ.

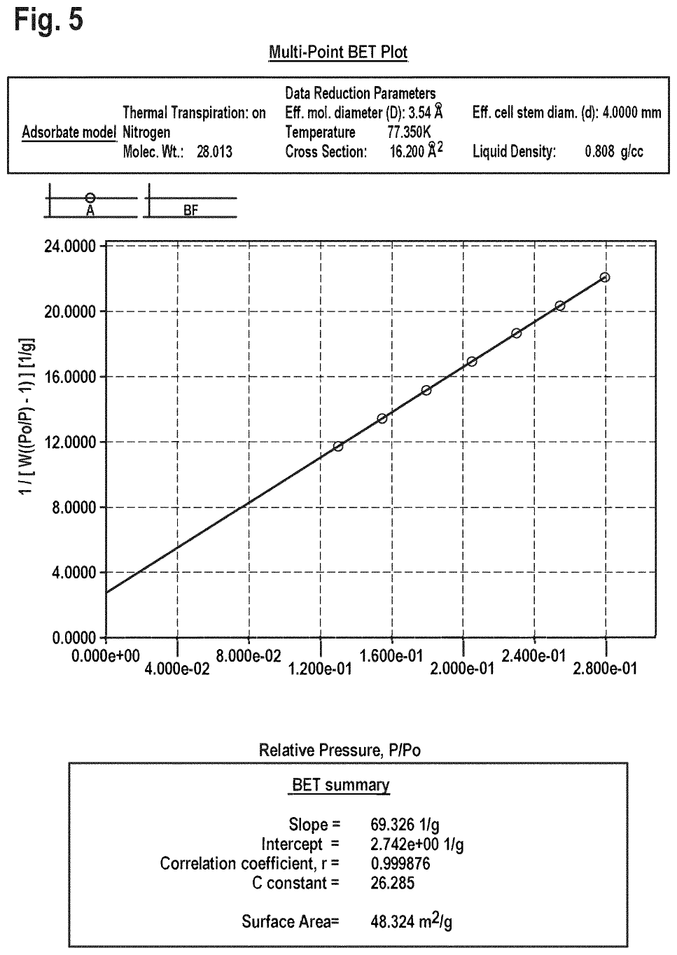

FIG. 6 shows absorption of the supernatant at 650 nm vs. the used volume of beads, exemplarily shown for COOH-3-functionalized beads.

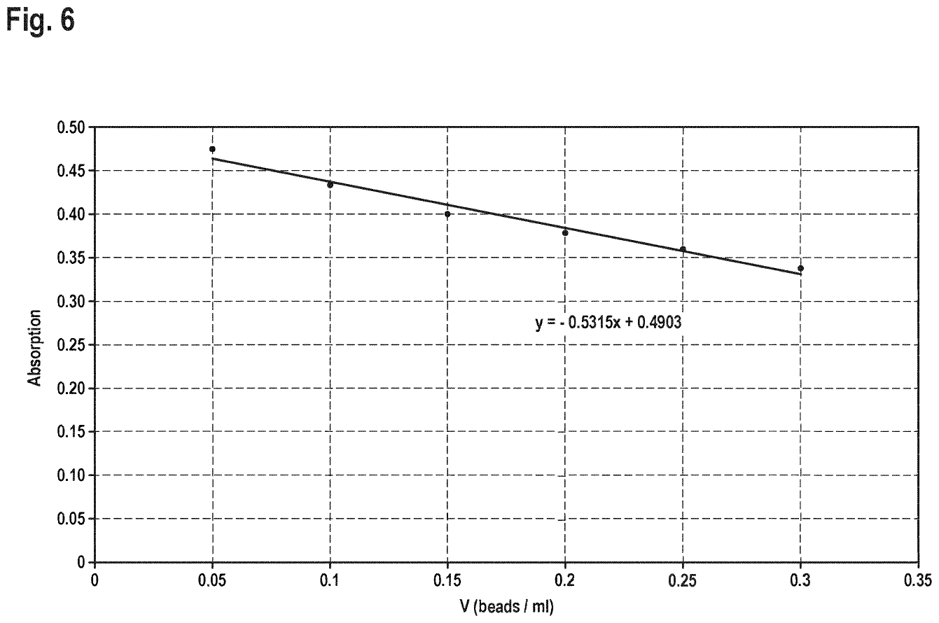

FIG. 7 shows the morphology (SEM) of core-shell particles with 1-5 silica layers (without sonication).

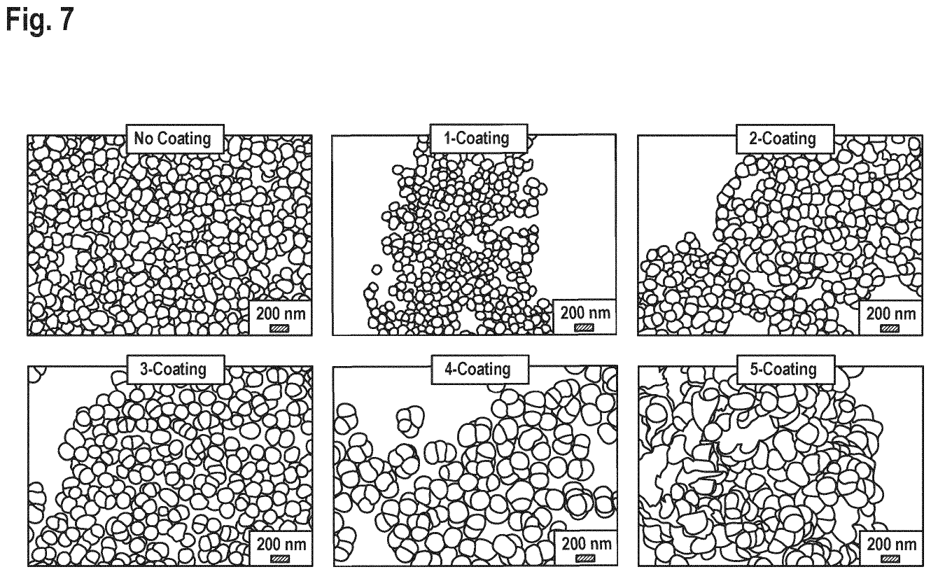

FIG. 8 shows the morphology (SEM) of core-shell particles with 1-5 silica layers (with sonication).

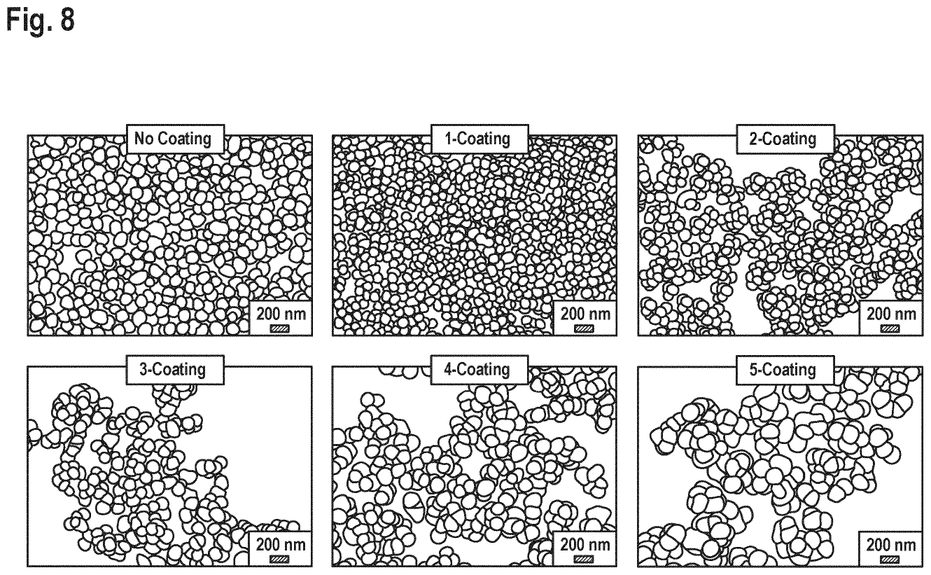

FIG. 9 shows the colloidal stability of core-shell particles in 7.5M HCl synthesized with (right) and without sonication (left). Numbers at the bottles represent the number of coating steps.

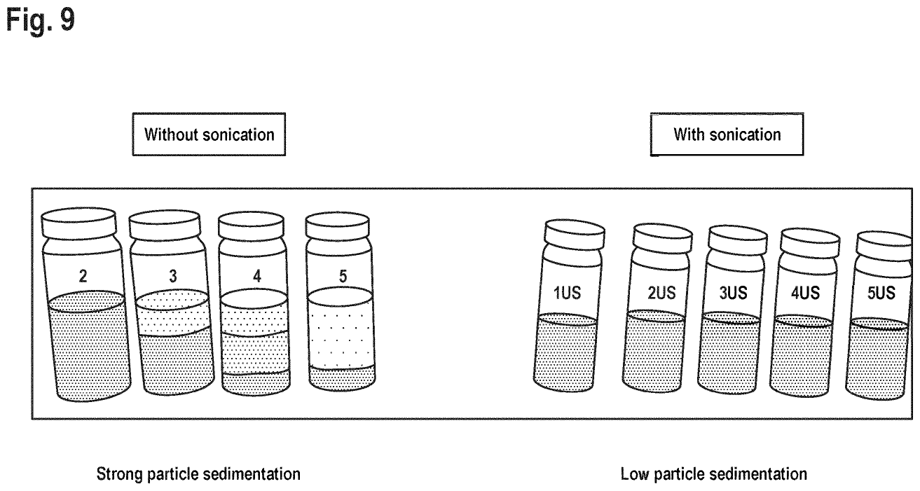

FIG. 10 shows the stability of core-shell particles (5-Silica layers) before (left) and after 10 days in 7.5M HCl (right).

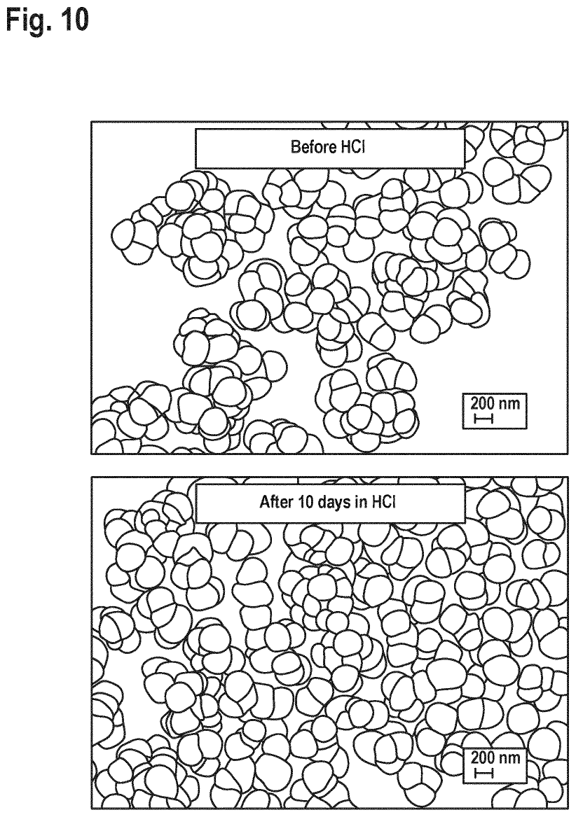

FIG. 11 shows the comparison of hydrophilic particles (left, reference) and hydrophobic particles (C18 & phenyl) in a mixture of water (bottom solution) and cyclohexane (upper solution).

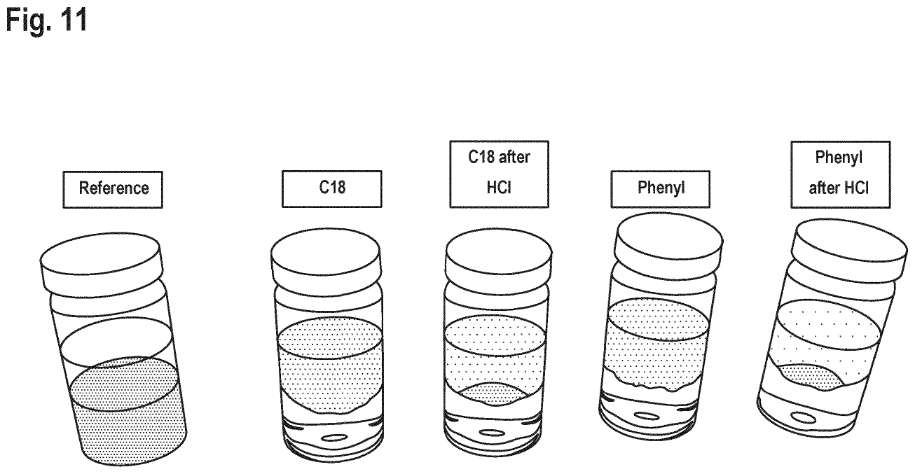

### CITED LITERATURE

[1] Yan et al., Journal of Alloys and Compounds 458 (2008) 487-491
[2] Liu et al., Angew. Chem. Int. Ed. 2009, 48, 5875-5879
[3] Y.-H. Deng et al./Colloids and Surfaces A: Physicochem. Eng. Aspects 262 (2005) 87-93
[4] W. Stöber, A. Fink, E. Bohn, J. Colloid Interface Sci. 26 (1968) 62.
[5] C. Chaneac, E. Tronc, et al., Nanostruct. Mater. 6 (1995) 715.
[6] G. M. Chow, K. E. Gonsalves, in: M. R. Zachariah, R. D. Shull, B. K. McMillin, P. Biswas (Eds.), in Nanotechnology: Molecularly Designed Materials, ACS Symposium Series, 622, ACS, Washington, D C, 1996, p. 42
[7] Faisal Mahtab, Yong Yu, Jacky W. Y. Lam, Jianzhao Liu, Bei Zhang, Ping Lu, Xixiang Zhang, and Ben Zhong Tang, Adv. Funct. Mater. 2011, 21, 1733-1740
[8] H. Pu et al./Materials Letters 60 (2006) 94-97
[9] Zhu et al, RSC Adv., 2012, 2, 1136-1143
[10] Dupont et al, Ind. Eng. Chem. Res. 2014, 53, 15222-15229
[11] Cendrowski et al., Applied Surface Science 407 (2017) 391-397
[12] Xin et al. CN108745321, Preparation method of virtual template-based molecularly imprinted magnetic microspheres for separating anthocyanin
[13] Jianlin et. al. CN109354210, Composite microbial water purifying agent and application thereof
[14] Yinya et al. CN104276667, Microbial water purifying agent for grass shrimp farming water and preparation method of microbial water purifying agent
[15] Zhiping et al. CN106622175, Strong-acid-resistant magnetic adsorption particle
[16] Zhiping et al. CN105118598, Strong-acid-resisting magnetic particle
[17] Rong et al. Journal of Radioanalytical and Nuclear Chemistry (2016), 308(2), 599-608
[18] A. Henning, A. Hoffmann, T. Thiele, U. Schedler, U. Resch-Genger Anal. Chem 2011, 83, 4970-4974
This patent application claims the priority of the European patent application 21210509.2, wherein the content of this European patent application is hereby incorporated by references.

1. A method for preparing a magnetic bead comprising at least one magnetic particle (M) and a silica coating, wherein the silica coating comprises at least two silica layers, the method comprising:
(a) providing at least one magnetic particle (M) having a first silica layer on its outer surface;
(b) dispersing the at least one magnetic particle (M) having a first silica coating on its outer surface according to (a) in an alcoholic solvent thereby obtaining a dispersion of the at least one magnetic particle (M) having a first silica layer on its outer surface;
(c) adjusting the pH of the dispersion obtained in (b) to a value of >7, thereby obtaining a basic dispersion of the at least one magnetic particle (M) having a first silica layer on its outer surface; and
(d) adding a silica source to the dispersion of the at least one magnetic particle (M) having a first silica layer on its outer surface obtained in (c);
thereby obtaining a dispersion comprising a magnetic bead comprising at least one magnetic particle (M) and a silica coating, wherein the silica coating comprises two silica layers;
wherein at least one of steps (b), (c) and (d) is/are done under sonication, wherein sonication is done with an amplitude (peak-to-peak) in the range of from 50 to 250 μm.

2. The method of claim 1, wherein at least steps (b) and (c) and/or (d) are done under sonication, and/or wherein (ultra)sonication is done with an (ultra)sonic amplitude (peak-to-peak) in the range of from 90 to 180 μm.

3. The method of claim 1, further comprising:
(e) separating a magnetic bead comprising at least one magnetic particle (M) and a silica coating, wherein the silica coating comprises two silica layers, from the dispersion obtained in (d).

4. The method of claim 2, further comprising
(f) providing at least one magnetic particle (M) having a first silica layer on its outer surface and a second silica layer on the first silica layer; and repeating the sequence of steps (b), (c), (d) and optionally (e) at least once, thereby obtaining a magnetic bead comprising at least one magnetic particle (M) and a silica coating, wherein the silica coating comprises in the range of from 3 to 10 silica layers.

5. A magnetic bead comprising at least one magnetic particle (M) and a silica coating, wherein the silica coating comprises at least two silica layers, obtained or obtainable from the method according to claim 1.

6. A magnetic bead comprising
(i) at least one magnetic particle (M) and
(ii) a silica coating, wherein the silica coating comprises at least two silica layers;
wherein the magnetic bead is stable against 7.5 M hydrochlorid acid and has a metal (cation) leaching rate in 7.5 M hydrochloric acid in the range of from 0.1 to 10%, wherein the metal (cation) leaching is determined according to a complex formation of Fe²⁺ with bathophenanthroline.

7. The magnetic bead of claim 6, having a stability against acids, wherein the value of the magnetization of the magnetic bead after an acid treatment changes by less than 6%.

8. The magnetic bead of claim 6, wherein the silica coating according to (ii) comprises in the range of from 2 to 10 silica layers.

9. The magnetic bead of claim 6, wherein the magnetization loss per layer is in the range of from 5 to 25 Am²/kg. per silica layer.

10. The magnetic bead of claim 6, having a metal (cation) leaching rate in 7.5 M hydrochloric acid in the range of from 0.5 to 5%, wherein the metal (cation) leaching in 7.5 M hydrochloric acid is determined according to a complex formation of Fe²⁺ with bathophenanthroline.

11. The magnetic bead of claim 6, having a stability against acids, wherein the value of the magnetic remanence of the magnetic bead after an acid treatment changes by <100% compared to the bead's magnetic remanence before acid treatment, wherein the acid treatment is a treatment with 7.5 M HCl for 30 minutes.

12. A functionalized magnetic bead comprising at least one magnetic bead according to claim 5, wherein an outer silica layer is functionalized with at least one group selected from the group consisting of amino group, azide group, alkyne group, carboxyl group, thiol group, epoxy group, aryl group and alkyl group.

13. A process for functionalizing a magnetic bead according to claim 5 comprising at least one magnetic particle (M) and a silica coating, wherein the silica coating comprises at least two silica layers, the process comprising
(A) providing a mixture comprising water and a magnetic bead comprising at least one magnetic particle (M) and a silica coating, wherein the silica coating comprises at least two silica layers;
(B) adding a compound comprising a silane part and a functional group, which is capable of reacting with a hydroxyl group, and optionally a base, which comprises ammonia, thereby obtaining a mixture comprising a magnetic bead comprising at least one magnetic particle (M) and a silica coating, wherein the silica coating comprises at least two silica layers and having one or more functional group(s) covalently bonded to its outer silica layer (functionalized magnetic bead); and
(C) optionally separating the functionalized magnetic bead from the mixture;
(D) optionally resuspending the functionalized magnetic bead in water or alcohol.

14. A method for preparing magnetic Fe₃O₄ supra particles comprising:
(a) providing a mixture of an iron halide and a C2 to C5 diol;
(b) combining the iron halide according to (a) with a mixture comprising at least sodium acetate and C2 to C5 diol, and obtaining a mixture comprising iron halide, sodium acetate and C2 to C5 diol; and
(c) keeping the mixture obtained in (b) at a temperature in the range of from 150 to 250° C., at a pressure in the range of from 2 to 20 bar, thereby obtaining a mixture comprising magnetic Fe₃O₄ supra particles.
